(19) United States
(12) Patent Application Publication
(10) Pub. No.: US 2011/0166872 A1
(43) Pub. Date: Jul. 7, 2011

(54) AUTO-SUBSTANTIATION FOR HEALTHCARE UPON SPONSOR ACCOUNT THROUGH PAYMENT PROCESSING SYSTEM

(76) Inventors: Karen L. Cervenka, Belmont, CA (US); Stacy Pourfallah, Oakland, CA (US); Mary Theresa Taylor, San Francisco, CA (US)

(21) Appl. No.: 12/855,623

(22) Filed: Aug. 12, 2010

Related U.S. Application Data
(60) Provisional application No. 61/234,262, filed on Aug. 14, 2009.
(60) Provisional application No. 61/237,236, filed on Aug. 26, 2009.

(51) Int. Cl. G06Q 50/00; G06Q 10/00

(52) U.S. Cl. 705/2

(57) ABSTRACT

An issuer receives an authorization request from healthcare provider that includes an account, an identifier for a healthcare service and its cost to a patient, and an identifier for a single purpose card for the redemption of the cost of the healthcare service. The issuer validates use of the account to pay the cost, sends an authorization approval to the healthcare provider, and deactivates the identifier for the single purpose card for future use. A request for insufficient funds, when the account is determined to be deficient, is sent to a sponsor to whom the issuer issued account. The cost in the authorization request can include a total purchase amount and a qualified amount of the total purchase amount, and the issuer can validate that the account can be used the for payment of the qualified amount of the total purchase amount for the healthcare service.

### CROSS-REFERENCE TO RELATED APPLICATIONS

This application claims priority to, and the benefit of, U.S. Provisional Application Ser. No. 61/234,262, titled “Vaccine Redemption Prepaid Card Through Payment Processing System,” filed on Aug. 14, 2009, and to U.S. Provisional Application Ser. No. 61/237,236, titled “Auto-Substantiation For Healthcare Upon Sponsor Account Through Payment Processing System,” filed on Aug. 26, 2009, both of which are incorporated herein by reference.

This application hereby incorporates by reference each of the following five (5) applications: (i) U.S. patent application Ser. No. 12/648,054, titled “Product Level Payment Network Acquired Transaction Authorization,” filed on Dec. 28, 2009; (ii) U.S. patent application Ser. No. 11/230,761, titled “Auto Substantiation For Over-The-Counter Transactions,” filed Sep. 20, 2005, now U.S. Pat. No. 7,650,308; (iii) U.S. Provisional Application No. 60/641,483, filed Jan. 4, 2005, entitled “Method and System for Determining Healthcare Eligibility”; (iv) U.S. Provisional Application No. 60/641,464, filed Jan. 4, 2005, entitled “Method for Encoding Messages Between Two Devices for Transmission Over Standard Online Payment Networks”; and (vi) U.S. Provisional Application No. 60/641,597, filed Jan. 4, 2005, entitled “Auto Adjudication for Over-the-Counter Transactions”.

### FIELD

The present invention relates generally to a prepaid or entitlement card for a payment processing system, and more particularly to a prepaid or a healthcare service, and most particularly to a prepaid or entitlement card that identifies a specific healthcare service and can be used by a patient at a healthcare service provider to obtain the healthcare service of administering a controlled substance for which the patient does not have a prescription, the prepaid or entitlement card being associated with one or more accounts of third parties who are financially response for reimbursing the healthcare service provider for the cost of providing the controlled substance and the specific healthcare service to the patient.

### BACKGROUND

A vaccine is a biological preparation that improves immunity to a particular disease. A vaccine typically contains a small amount of an agent that resembles a microorganism. The agent stimulates the body's immune system to recognize the agent as foreign, destroy it, and “remember” it, so that the immune system can more easily recognize and destroy any of these microorganisms that it later encounters. Vaccines can be prophylactic (e.g. to prevent or ameliorate the effects of a future infection by any natural or “wild” pathogen), or therapeutic (e.g. vaccines against cancer are also being investigated; see cancer vaccine).

As the drug used in a vaccine is typically a controlled substance regulated by a governmental body, rather the self medicating as an over-the-counter drug, a patient normally must have the vaccine administered a healthcare service provider. The cost of the vaccine, as well as the cost of administering the vaccine to the patient, are typically paid for by an insurance company, where the patient is either the insured or a person for which the patient is financially responsible. After receiving a vaccine, a claims is filed for the insured for the cost of the healthcare goods and services against an insurance policy of the insured. Upon adjudication of the claim, the insurance company pays the healthcare service provider for the cost of the vaccine and the cost of administering the vaccine to the patient.

A patient's vaccine is typically paid for by the patient's insurance company. Substantiation of a healthcare service provided by a healthcare service provider for an insured's insurance policy, and adjudication of the resultant insurance claim for the healthcare service so provided can involve numerous parties that are required to perform numerous functions. Often, these functions must be performed at substantial overhead costs and before the health service provider can be reimbursed for rendering the healthcare service to the patient. In would be an advantage in the relevant arts to provide healthcare service payments to healthcare service providers, such as for vaccine shots, without insurance claims system adjudication by a healthcare benefits management entity. Also, there is a need for a system that reduces the costs incurred by healthcare service providers and their patients in the former providing healthcare services to the latter.

### SUMMARY

In one implementation, a payment network authorization request message originating from an address of a healthcare provider is received at an address of an issuer of a healthcare service sponsor account from an address of a transaction handler. The payment network authorization request message includes: (i) a healthcare service sponsor account identifier for the healthcare service sponsor account issued by the issuer to a sponsor who is financially responsible for reimbursing the healthcare provider for a cost of providing a healthcare service to a patient; (ii) an identifier for the healthcare service; (iii) an amount for the cost of providing the healthcare service to the patient; and (iv) an identifier, corresponding to the healthcare service sponsor account, that is globally unique for a single purpose card redeemable by a bearer thereof for the redemption of the cost of providing the healthcare service. The payment network authorization request message, however, does not include information that identifies for the patient. The healthcare service sponsor account is validated for use to pay the cost of providing a healthcare service to a patient. An authorization approval message is sent from the address of the issuer of the healthcare service sponsor account for delivery to the address of the healthcare provider through the transaction handler and in response to the payment network authorization request message. A deactivation is made for future use of the identifier, corresponding to the healthcare service sponsor account, that is globally unique for the single purpose card. When the healthcare service sponsor account has insufficient funds to reimburse the healthcare provider for the qualified amount of the total purchase amount, a request for the insufficient funds is sent for delivery to an address of the sponsor.

In another implementation, information encoded in a portable consumer payment device is read, including: (i) a healthcare service to be administered by a healthcare provider to a patient; (ii) a controlled substance for which the patient does not have a prescription; and (iii) a healthcare service sponsor account identifier for a healthcare service sponsor account issued to a sponsor who is financially responsible for reimbursing the unidentified healthcare provider for the cost of providing the healthcare service to the patient by payment from the healthcare service sponsor account for an administration of the controlled substance by the healthcare provider to the patient. A match is found of a healthcare service inventory code corresponding to the healthcare service and a match is found of the healthcare service inventory code to a qualified healthcare service category under the healthcare service sponsor account. A transmission is formed containing a payment network authorization request message requesting use of the healthcare service sponsor account for a payment transaction request for the healthcare service. The payment network authorization request message includes: (i) a total purchase amount for the matching obtained healthcare service inventory code; and (ii) a qualified amount of the total purchase amount eligible for use of the healthcare service sponsor account for the payment transaction request for the healthcare service. The payment network authorization request message, however, does not include information that identifies the patient. The payment network authorization request message is sent from an address of the healthcare provider for delivery to an address of an issuer of the healthcare service sponsor account. An authorization approval message originating from the address of the issuer of the healthcare service sponsor account is received at the address of the healthcare provider in response to the payment network authorization request message.

Another implementation includes a method of authorizing a payment transaction request through a payment network for a healthcare service to be administered by a healthcare provider to a patient, wherein the payment transaction is conducted upon a healthcare service sponsor account. The method includes obtaining a healthcare service sponsor account identifier for the healthcare service sponsor account. The healthcare service sponsor account identifier is encoded in a portable consumer payment device. The portable consumer payment device contains encoded information that identifies the healthcare service that is to be administered to a patient. The healthcare service includes a controlled substance for which the patient does not have a prescription, and an administration of the controlled substance by the healthcare provider to the patient. The healthcare service sponsor account is issued to a sponsor who is financially responsible for reimbursing the healthcare provider for the cost of providing the healthcare service to the patient. A determination is made that the obtained healthcare service sponsor account identifier is valid by matching the healthcare service sponsor account identifier against a stored set of healthcare service sponsor account identifiers. For the matching healthcare service sponsor account identifier, a healthcare service inventory code corresponding to the healthcare service is obtained. Determinations are made: (i) that the obtained healthcare service inventory code matches a qualified healthcare service category under the healthcare service sponsor account; (ii) of a total purchase amount for the matching obtained healthcare service inventory code; and (ii) of a qualified amount of the total purchase amount eligible for use of the healthcare service sponsor account. For the matching obtained healthcare service inventory code, a transmission is formed containing a payment network authorization request message requesting use of the healthcare service sponsor account for payment for the healthcare service. The payment network authorization request message includes the total purchase amount for the matching obtained healthcare service inventory code, and the qualified amount of the total purchase amount eligible for use of the healthcare service sponsor account for the payment transaction request for the healthcare service. The payment network authorization request message, however, does not includes an identification of the patient. The payment network authorization request message is sent from an address of the healthcare provider for delivery, through an acquirer for the healthcare provider and through a transaction handler, to an address of an issuer of the healthcare service sponsor account who issued to the healthcare service sponsor account to the sponsor. An authorization approval message originating from the address of the issuer is received at the address of the healthcare provider in response to the payment network authorization request message.

Yet other implementations include a portable payment device having a substrate in contact with memory having encoded data corresponding to a specific healthcare service to be rendered to a patient by a healthcare service provider by administering a controlled substance for which the patient does not have a prescription, where the portable payment device is associated with one or more accounts of third parties who are financially response for reimbursing the healthcare service provider for the cost of providing the controlled substance and the specific healthcare service to the patient. In other implementation, the portable payment device is a prepaid or entitlement card, or equivalent voucher, that is an open loop card that is accepted by many different healthcare service providers who will provide the patient with the specific healthcare service. In still further implementations, the prepaid or entitlement card does not identify the patient so that, in processing payment for the healthcare service, the patient can be anonymous to the entities in the payment processing system (e.g., issuer, acquirer and transaction handler) as well as to the healthcare service provider who provides the specific healthcare service to the patient. The healthcare service provider is reimbursed from an account identified by data on the prepaid or entitlement card. The identified account can correspond to one or more sponsors who are financially responsible to reimburse the healthcare service provider for rendering the specific healthcare service to the patient. An authorization for the cost of the service, and its guaranteed payment to the healthcare service provider, can be provided in real time by way of an automatic substantiation process, without a benefits manager adjudication, without substantiation of the healthcare service against an insurance policy or formulary, and without an insurance claims system process.

### BRIEF DESCRIPTION OF THE DRAWINGS

Implementations of the invention will become more apparent from the detailed description set forth below when taken in conjunction with the drawings, in which like elements bear like reference numerals.

FIG. 1 illustrates an exemplary environment for delivery of prepaid or entitlement card, or their equivalent, to a patient who is to receive a specific healthcare service to be paid for from an account identified by data encoded on the prepaid or entitlement card.

FIG. 2 illustrates possible alternative implementations of a prepaid or entitlement card.

FIG. 3 depicts an environment within a payment processing network seen in FIG. 6 where a prepaid or entitlement card can be used by a patient to obtain a specific healthcare service to be paid for from an account identified by data encoded on the prepaid or entitlement card.

FIG. 4 depicts a flow chart of a first exemplary method in which a prepaid or entitlement card can be used at a Point of Service terminal for a patient to obtain a specific healthcare service to be paid for from an account identified by data encoded on the prepaid or entitlement card.

FIG. 5 depicts a flow chart of a second exemplary method for a patient to obtain a specific healthcare service to be paid for from an account corresponding to a prepaid or entitlement card.

FIG. 6 illustrates an exemplary payment processing network.

FIG. 7 illustrates a illustrates a flow diagram of a payment transaction authorization system in which the cost of the specific healthcare service to be assessed to the account identified by data encoded on the prepaid or entitlement card of FIG. 3 can be preliminarily subjected to an auto-substantiation process by way of authorization request in order to obtain an authorization.

FIG. 8 illustrates a flow chart demonstrating a method of implementing the authorization request of FIG. 7.

FIGS. 9-11 illustrate a flow chart demonstrating a method of implementing the authorization request of FIG. 7.

FIG. 12 illustrates a flow chart demonstrating a method of implementing a split tender according to one implementation.

FIGS. 13A-13C illustrates respective authorization requests in respective implementations.

FIG. 14 illustrates a flow diagram for implementing an auditing process for program compliance according to one embodiment of the invention.

FIG. 15 illustrates a flow chart demonstrating a method of auditing a coupon sponsor account according to one implementation.

FIGS. 16-17 illustrate a flow chart demonstrating a method of providing transaction data according to one implementation.

FIG. 18A illustrates a standard settlement record and transaction record in one implementation.

FIG. 18B illustrates a more detailed view of the transaction record portion of FIG. 18A in one implementation.

FIG. 18C illustrates an authorization response message in one implementation.

### DETAILED DESCRIPTION

The present discussion considers a prepaid or entitlement portable consumer device, such as a prepaid or entitlement card, that can be used by a patient for a specific healthcare service. For example, the healthcare service can be an administration of a controlled substance for which a patient does not have a prescription that is a biological preparation administered for improving an immunity of the patient to a particular disease. By way of example, and not by way of limitation, the healthcare service will be referred to herein as an influenza (i.e.; ‘Flu’) vaccine. In various implementations, an issuer of an account would partner with businesses, non-profits, and/or government agencies to issue a prepaid or entitlement card. The account would provide funds, supplied by the partners, to healthcare providers to reimburse them for providing flu vaccines to patients who presented a valid flu vaccine prepaid or entitlement card. The vaccine prepaid or entitlement card would be used by patients to obtain a free flue vaccine from participating healthcare service providers, such as retailers with flu shot clinics (e.g.; supermarkets, ‘big box’ stores), doctors, and medical facilities and other such merchants. The vaccine prepaid or entitlement card can be a plastic magnetic stripe card to facilitate authorization, clearing, and settlement through a typical Point-of-Server terminal (POS) and related systems and processes that such merchants would typically use for other transactions with consumer-account holders who conduct transactions on accounts that are processed by a payment processing network. The card can be used at more than one retailer and can be good for the healthcare service, regardless of the price of administering the healthcare service. Different prices may be paid by a sponsor to different healthcare providers (e.g., large chain pharmacy retailers) based on different negotiated prices for administering the healthcare service. Thus, there can be different prices for administering the healthcare service at different healthcare providers.

In one implementation, a payment transaction request is authorized through a payment network for a flu vaccine administered by a healthcare provider to a patient. The payment transaction is conducted upon a flu vaccine sponsor account. There is obtained, at an electronic cash register, a flu vaccine sponsor account identifier for the flu vaccine sponsor account. The flu vaccine sponsor account identifier is encoded on a prepaid or entitlement card. The prepaid or entitlement card contains encoded information that identifies the flu vaccine. The prepaid or entitlement card does not contain an identification of the patient to whom the flu vaccine is to be given. The flu vaccine service being provided includes a controlled substance (e.g.; the vaccine) for which the patient does not have a prescription, and an administration of the controlled substance (e.g.; giving a flu vaccine shot) by the healthcare provider to the patient. The flu vaccine sponsor account is issued by an issuer to a sponsor who is financially responsible for reimbursing the healthcare provider for the cost of providing the flu vaccine to the patient.

A determination is made, using the electronic cash register, that the obtained flu vaccine sponsor account identifier is valid by matching the flu vaccine sponsor account identifier against a stored set of flu vaccine sponsor account identifiers. For the matching flu vaccine sponsor account identifier, and using the electronic cash register, there is obtained a flu vaccine inventory code corresponding to the flu vaccine. A determination is made that the obtained flu vaccine inventory code matches a qualified flu vaccine category under the flu vaccine sponsor account A determination is also made as to a total purchase amount for the matching obtained flu vaccine inventory code, and also as to a qualified amount of the total purchase amount eligible for use of the flu vaccine sponsor account for the payment transaction request for the flu vaccine.

For the matching obtained flu vaccine inventory code, a transmission is formed containing a payment network authorization request message requesting use of the flu vaccine sponsor account for the payment transaction request for the flu vaccine, The payment network authorization request message includes the total purchase amount for the matching obtained flu vaccine inventory code, and also includes the qualified amount of the total purchase amount eligible for use of the flu vaccine sponsor account for the payment transaction request for the flu vaccine.

In alternative of the foregoing implementation, the authorization request message can include a description field for the matching obtained flu vaccine inventory code. The authorization request message can also include tax on the flu vaccine. When different flu vaccines are administered, the authorization request message can also include the total purchase amount for the respective flu vaccines and the qualified amount of the total purchase for each flu vaccine, as well as a description field for each flu vaccine.

In alternative of the foregoing implementation, the method can include storing a set of the qualified flu vaccine categories that are eligible for usage under the flu vaccine sponsor account, wherein the set of qualified flu vaccine categories is accessible via the electronic cash register, and also storing a set of the account identifiers for identifying a set of the flu vaccine sponsor accounts, where the set of the account identifiers is accessible via the electronic cash register.

In alternative of the foregoing implementation, an audit can be conducted for usage of the sponsor account, such as by steps that include preparing with a computer a transaction record of the payment transaction request, and sending the transaction record to an auditor of the flu vaccine sponsor account. In a batch mode, there can be received a plurality of the transaction records from a plurality of merchants (e.g., healthcare service providers) at an issuer of the flu vaccine sponsor account, then grouping the transaction records received from the plurality of merchants and associated with the particular flu vaccine sponsor account as a set of the transaction records, and then sending the set of the transaction records from the issuer to the auditor. Note that there can be appended to the transaction record a payment network settlement record submitted to an issuer. There can be a utilizing of the payment network settlement record to complete payment for the payment transaction request while forwarding the transaction record to the auditor for monitoring flu vaccine sponsor account compliance.

In alternative of the foregoing implementation, when the authorization approval message is for a partial amount of the total purchase price, a payment can be obtained, via a payment source other than the flu vaccine sponsor account, for the difference between the total purchase amount for the matching obtained flu vaccine inventory code and the qualified amount of the total purchase for the respective flu vaccine.

In the foregoing implementations, the prepaid or entitlement card can be a smart card having a Radio Frequency Identification (RFID) tag, a transponder device and a microchip, a magnetic stripe card, or a combination of these. Also, the prepaid or entitlement card can have memory means for receiving information by a communication technology that can be that of a wireless communication, a hardwired communication, or a magnetic encoded communication for track data received by modifying the magnetism of magnetic particles on a band of magnetic material on the prepaid or entitlement card.

In the foregoing implementations, the information that identifies the flu vaccine healthcare service that is to be rendered can be a Stock Keeping Unit (SKU), a Universal Product Code (UPC), a trademark, a commodity type and a trade name of a provider of the commodity type, a National Drug Code (NDC), an ingredient of the commodity type and the trade name of the provider of the commodity type, or a combination of these.

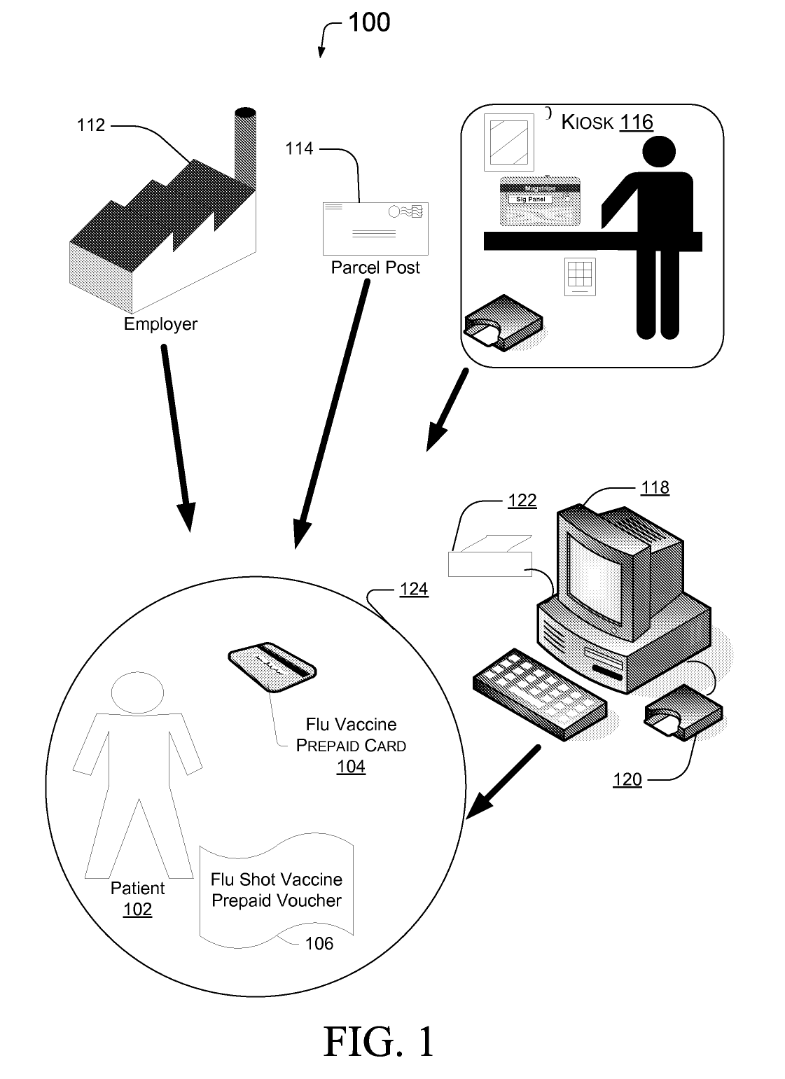

FIG. 1 shows examples of who a patient 102 may receive a flu vaccine prepaid or entitlement card 104 or an equivalent voucher 106. An entitlement card or voucher corresponds to a payment for a healthcare service that is to be made after the entitlement card has been redeemed by a bearer thereof with a healthcare provider, where the redemption is at a pre-negotiated price for the healthcare service that is pre-negotiated prior to delivery of the healthcare service to a patient. A prepaid or entitlement card corresponds to a payment for the healthcare service after redemption of the prepaid or entitlement card by a bearer thereof, wherein the redemption is made from prepaid funds on deposit in a healthcare service sponsor account.

An employer 112 of the patient, or one who is financially responsible for the patient 102, may distribute prepaid or entitlement cards to its employees. The prepaid or entitlement card can be ordered from an issuer, or its agents, and received via a postal service 114. A flu vaccine prepaid or entitlement card can be obtained by paid to, and operation of, a prepaid or entitlement card dispensing kiosk 116. A paper voucher 106 can be rendered by a printer 122 in communication with a computing apparatus 118 operated by the patient 102, or agent thereof, which voucher encodes an account of a vaccine sponsor. Data rendered with the voucher 106 can be received via the World Wide and/or Internet from the vaccine sponsor or agent thereof.

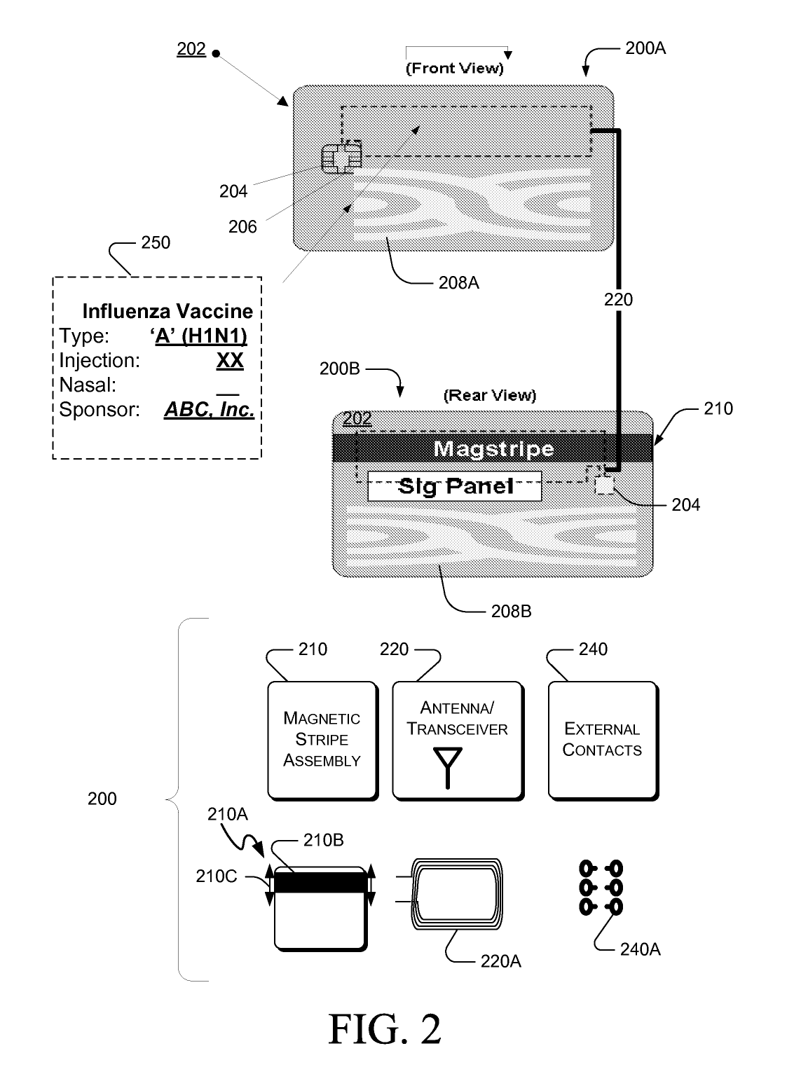

Turning to FIG. 2, both a front view 200A and a rear view 200B of an exemplary flu vaccine prepaid or entitlement card 202 are presented. Images may be displayed on both sides of flu vaccine prepaid or entitlement card 202, with image 208A on the front view 200A being either the same as or different from image 208B on the rear view 200B. In this illustration, the front view 200A also displays information about the provider of the flu vaccine prepaid or entitlement card.

FIG. 2 also shows exemplary implementations of a data encoding area of flu vaccine prepaid or entitlement card 202. The data encoding area may include an optional shielding element, which allows desired electromagnetic, optical, or radiative signals to penetrate while protecting the data encoding area from physical abuse or damage. Flu vaccine prepaid or entitlement card 202 may optionally have areas outside of the data encoding area shielded from physical abuse or otherwise acceptable forms of electromagnetic radiation. Some of the acceptable signals that are allowed to penetrate the shielding and may include, but are not limited to, signals accompanying a magnetic field, RFID signals, IrDA signals, visible light, invisible light, modulated laser, and/or modulated RF communication signals. By way of example and not limitation, a selective shielding element may comprise a clear plastic shield, conformal coatings, an opaque plastic shield, or a clear thin film, depending on the implementation of the data encoding area.

Non-limiting examples of the data encoding area are shown at reference numeral 200, and include an integrated circuit or ‘chip’ 204 having contact(s) 206, a magnetic stripe assembly 210, an antenna and/or transceiver 220, and electrical contacts 240. Magnetic stripe assembly 210 may comprise, in the implementation shown as 210A, a reprogrammable magnetic stripe assembly 210B that accepts data and/or commands from a processor and formats and renders that data into a form on a magnetic stripe that is readable by conventional merchant magnetic stripe-reading point of sale (POS) terminals. In this manner, the processor may program a particular account for use in a transaction as a function of user input selecting the account. Alternatively, the processor may erase the magnetic stripe of assembly 210, rendering the card useless in the event of its loss or theft. In the implementation shown as 210A, magnetic stripe assembly 210B at least partially slidably moves 210C into and out of an assembly of flu vaccine prepaid or entitlement card 202 (partial view shown), allowing flu vaccine prepaid or entitlement card 202 to conduct a transaction at a point of sale terminal that includes a magnetic stripe reader.

Flu vaccine prepaid or entitlement card 202 can bear, on a surface thereof, an image 250 of various indicia which may identify the specific healthcare service to be provided to the patient by a healthcare service provider to whom the prepaid or entitlement card is presented. The flu vaccine prepaid or entitlement card 202, in some implementation, will not encode data sufficient to identify the patient who is to receive the specific healthcare service. As such the patient can be anonymous to the entities in the payment processing system (e.g., issuer, acquirer and transaction handler) as well as to the healthcare service provider who provides the specific healthcare service to the patient. Despite the privacy of the patient being maintained by implementations disclosed herein, the healthcare service provider can still be reimbursed from an account identified by data on the flu vaccine prepaid or entitlement card 202. Also, the identified account encoded on the flu vaccine prepaid or entitlement card 202 can correspond to one or more sponsors who are financially responsible to reimburse the healthcare service provider for rendering the specific healthcare service to the patient. As such, the authorization for the cost of the service, and its guaranteed payment to the healthcare service provider, can be provided in real time, without a benefits manager adjudication, without substantiation of the healthcare service against an insurance policy or formulary, and without an insurance claims system process.

Memory, such as may be contained in chip 204, can have encoded therein, but is not limited to; (i) an identifier for the type, kind, manufacturer, wholesaler, of the controlled substance and/or its manner of administration, which may be identified, for instance by Universal Product Code, Stock Keeping Unit, or the other indicia (e.g., UPC, SKU, Bar Code data, etc); (ii) a sponsor who is the account holder for the account from which a healthcare service provider is to be paid of the cost of administering the vaccine to the patient; and (iii) other relevant indicia such as a map and/or location of where a flu shot can be obtained.

Continuing with FIG. 2, another implementation of the data encoding area is shown as an antenna and/or transceiver 220. Antenna and/or transceiver 220 may include commonly used loop inductors such as the one shown 220A or in those shown in related ISO standards for RF-readable smart cards. With such an interface, account data may be translated, modulated and transmitted in a manner acceptable by an RF contactless merchant POS terminal, a 802.11 Wi-Fi or Wi-Max network, or by a cellular or RF communications network. For instance, antenna and/or transceiver 220 may receive a wireless communication from a card read-write device, where the wireless communication carries data for a sponsor's account that is to be written in memory to the data encoding area 200.

Electrical contacts 240 are yet another alternative implementation of the data encoding area shown in FIG. 2. With flu vaccine prepaid or entitlement card 202 possessing physical contacts such as an array of conductive pads or shapes 240A, flu vaccine prepaid or entitlement card 202 may be placed in physical contact with a merchant's POS terminal, and electrical contacts 240 may establish connectivity to the merchant's financial processing system. The processor may relay account-related information to the merchant's POS terminal through the contact interface, thereby allowing flu vaccine prepaid or entitlement card 202 to be utilized with the large number of preexisting merchant POS terminals without hardware and/or software upgrades or changes.

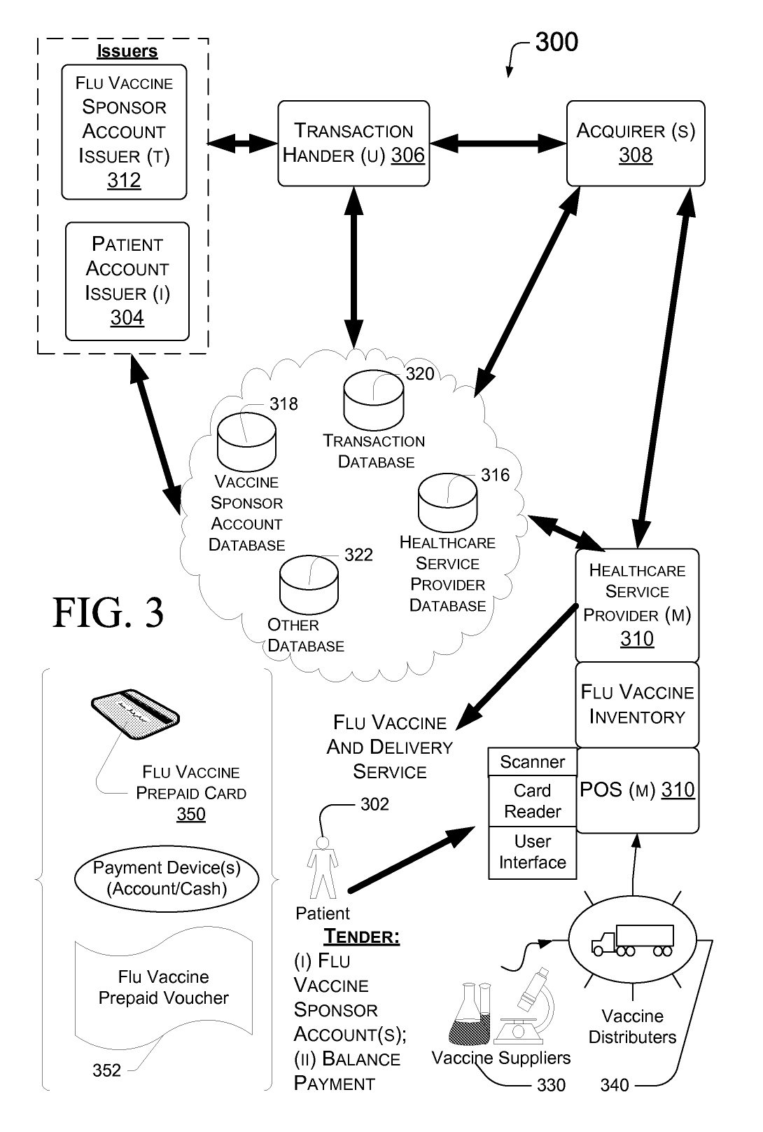

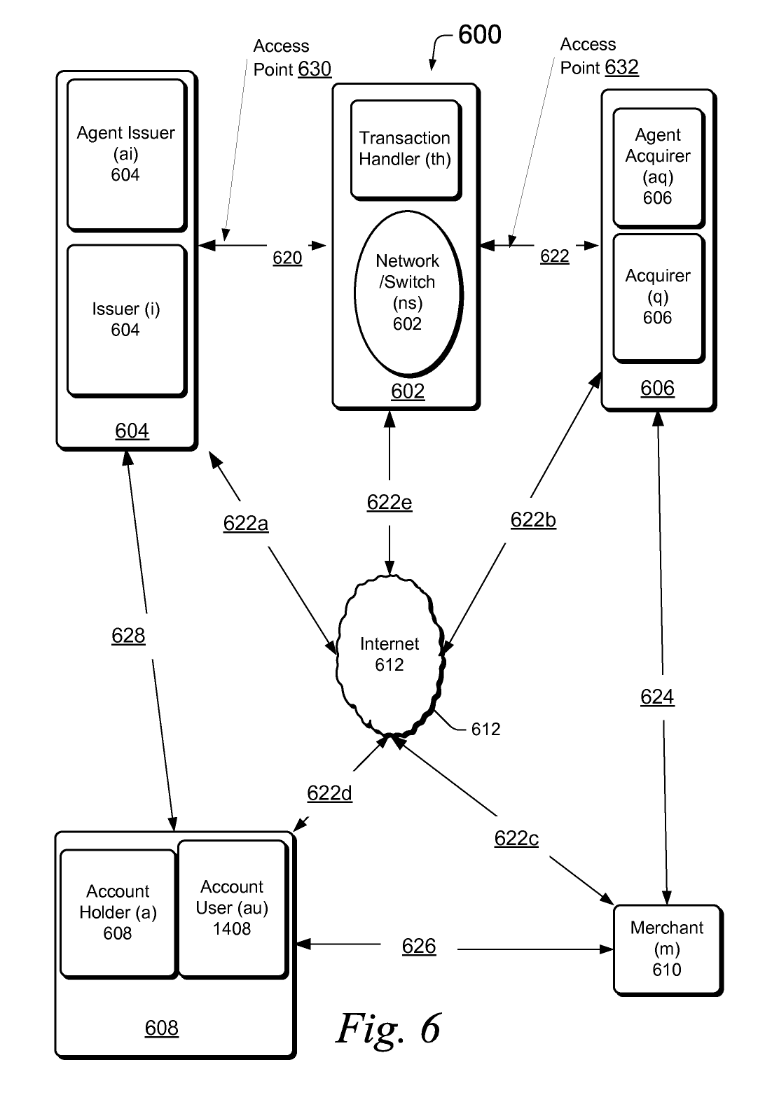

Within the exemplary payment processing system depicted in FIG. 6, discussed below, FIG. 3 illustrates the general environment wherein a coupon card, such as coupon card 202 (FIG. 2) obtained by the process described in connection with FIG. 1, is used by a consumer to receive a free, or discounted, flu shot. To start, one or more vaccine supplier(s) 330 manufacture vaccines for delivery to vaccine distributors 340 who provide vaccine inventory to healthcare service providers 310. Each healthcare service provider (m) 310 has a flu vaccine inventory and a Point of Service terminal (POS) (m) 310. The POS (m) 310 has a scanner, card reader, and user interface for performing transactions with consumers on accounts issued to the consumer or another to a different account holder such as a sponsor of a flu vaccine program or campaign.

At POS (m) 310, patient 302 presents to healthcare service provider (m) 310 flu vaccine prepaid or entitlement card 350 along with the item(s) patient 302 wishes to purchase. Healthcare service provider (m) 310 uses the card reader associated with POS (m) 310 to read the information stored on flu vaccine prepaid or entitlement card 350, including the account identifier associated with one or more sponsors of the vaccine program or campaign. In certain implementations, flu vaccine prepaid or entitlement card 350 is read by swiping flu vaccine prepaid or entitlement card 350 through POS (m) 310 to read data magnetically encoded in its magnetic stripe. In other implementations, POS (m) 310 reads flu vaccine prepaid or entitlement card 350 using a contactless technology, such as RFID, when patient 302 is near POS (m) 310. In yet other implementations, to be read, flu vaccine prepaid or entitlement card 350 is inserted into POS (m) 310 such that external contacts on flu vaccine prepaid or entitlement card 350 establish connectivity with POS (m) 310. In still other implementations, a flu vaccine prepaid voucher 352 is scanned by the scanner of POS (m) 310, or codes thereon input into POS (m) 310 at the User Interface.

In certain implementations, other information is also read from flu vaccine prepaid or entitlement card 350 or voucher 352, such as, by way of example and not limitation, an expiration date, an item type, or an item quantity. In such implementations, POS (m) 310 may determine whether the flu vaccine prepaid or entitlement card is valid for a healthcare service requested by patient 302. This may occur, by way of example and not limitation, by comparing the current date with the expiration data of the flu vaccine prepaid or entitlement card. Alternatively, POS (m) 310 may determine whether patient 302 has requested the specific flu vaccine and quantity specified by data on the card. In still further implementations, the expiration date of the card can correspond to the end of the flu season.

In one implementation, patient 302 additionally provides flu vaccine prepaid voucher 352 to healthcare service provider (m) 310. Flu vaccine prepaid voucher 352 has a bar code printed thereon that identifies the specific healthcare service (e.g., the type, kind, quantity, etc., of fly vaccine) for which the sponsor's account can be use for payment to the healthcare service provider for the benefit of the patient. In such an implementation, the bar code is scanned with a scanner associated with POS (m) 310 to identify the specific vaccine.

In certain implementations, healthcare service provider (m) 310 may additionally enter the cost of providing the vaccine to the patient into POS (m) 310. In such implementations, the amount may also be printed on flu vaccine prepaid voucher 352 (e.g.; as a maximum authorized amount). In other implementations, the amount is read by POS (m) 310 from flu vaccine prepaid or entitlement card 350 (e.g.; as a maximum authorized amount). In certain implementations, POS (m) 310 calculates the maximum authorized amount for the specific vaccine. This may occur, by way of example and not limitation, where the cost is valid when the patient is also making other purchases from the healthcare service provider (m) 310.

Upon receipt of flu vaccine prepaid or entitlement card 350, the transaction is processed similarly to a method described below in connection with an environment 600 depicted in FIG. 6. Healthcare service provider (m) 310 submits an authorization request to acquirer (s) 308 via POS (m) 310, which includes the account identifier read from flu vaccine prepaid or entitlement card 350.

In certain implementations, the authorization request may additionally include an account identifier associated with patient 302 where patient 302 has paid an additional amount for the vaccine and/or for still other items by use of the patient's credit card, debit card, or other portable consumer payment device.

Where acquirer (s) 308 is not the same entity as flu sponsor account issuer (t) 312, acquirer (s) 308 forwards the transaction information to a transaction handler (u) 306, who in turn forwards it to flu sponsor account issuer (t) 312 to verify that the account associated with flu vaccine sponsor account issuer (t) 312 contains sufficient funds to reimburse healthcare service provider (m) 310 for the specific healthcare service to be provided to the patient 302. Of course, if the patient 302 is also making other payments using other accounts, other authorization requests are send to the corresponding patent account issuer (i) 304 of the patent account.

Upon receipt of a reply from flu sponsor account issuer (t) 312 (i.e.; an authorization response), transaction handler (u) 306 forwards the authorization response to acquirer (s) 308, who forwards it to POS (m) 310 of healthcare service provider (m) 310. Where the authorization response contains an approval of the use of the flu vaccine prepaid or entitlement card, patient 302 can receive the specifically identified flu short service from the healthcare service provider (m) 310 either without cost or at a discount with the balance of the cost being tendered by the patient 302.

In certain implementations, healthcare service provider (m) 310 invalidates or deletes data corresponding to a flu vaccine that is stored on flu vaccine prepaid or entitlement card 350 using POS (m) 310 once the discount has been applied. In certain implementations, flu vaccine prepaid or entitlement card 350 (and voucher 352) may be a one-time use card. In such an implementation, healthcare service provider (m) 310 may forgo returning flu vaccine prepaid or entitlement card 350 to patient 302. In other implementations, flu vaccine prepaid or entitlement card 350 may be used to store subsequent flu vaccine credits or service entitlements and therefore is returned to patient 302. In still other implementations, the issuer (i) 304 may invalidate a code(s) that is/are associated with a flu vaccine entitlement or prepaid or entitlement card after the corresponding code has been used a predetermined number of times.

In certain implementations, approval of the transaction for the flu shot service may be more involved. In such implementations, the authorization request includes additional information, by way of example and not limitation, the item, the item type, and/or the sponsor of the flu vaccine prepaid or entitlement card. In certain implementations this information is forwarded by transaction handler (u) 306 to a third party (not shown) for authentication and/or other processing. In one implementation, healthcare service provider database 316 may be used to, by way of example and not limitation, verify that flu vaccine sponsor account issuer (t) 312 has issued the flu vaccine prepaid or entitlement card 350 that the patient 302 is attempting to use. In such an implementation, the authorization process may include a comparison, performed by the third party (not shown) of the additional information provided against information stored in healthcare service provider database 316. In yet other implementations, a third party (not shown) adds a notation to an identifier for the prepaid or entitlement card 350 or voucher 352 stored in healthcare service provider database 316 once it has been used by the patient 202, thereby preventing its use more than once. The third party (not shown) may have direct access to healthcare service provider database 316 or may access healthcare service provider database 316 via transaction handler (u) 306.

In other implementations, the third party (not shown), who may be an agent of the flu vaccine sponsor, uses healthcare service provider database 316 to keep a tally of the flu vaccine prepaid or entitlement cards used by patients 302. In such an implementation, this information is used by flu vaccine sponsor account issuer (t) 312 in deciding future flu vaccine prepaid or entitlement cards to issue or for identifying specific patients 202 for targeted advertising. In still other implementations, the additional information includes an identifier for one or more advertisements that are to be, or were, presented to patient 302 at the time that flu vaccine prepaid or entitlement card 305 or voucher 352 was used by the patient. In such an implementation, after the information is stored in healthcare service provider database 316 by the third party, flu vaccine sponsor account issuer (t) 312 may charge another entity a fee for each time the advertisement is shown to the patient 302. Alternatively, flu vaccine sponsor account issuer (t) 312 may change the advertisement associated with an flu vaccine prepaid or entitlement card 350 or voucher 352 after the advertisement has been presented with the flu vaccine prepaid or entitlement card 350 or voucher 352 a given number of times.

In other implementations, vaccine sponsor account database 318 is used. As with healthcare service provider database 316, a third party (i.e.; an agent of a vaccine sponsor) may access vaccine sponsor account database 318 directly or via transaction handler (u) 306. Vaccine sponsor account database 318 may contain information regarding the account issued to each vaccine sponsor account issuer (t) 312, where flu vaccine sponsor account issuer (t) 312 is one of (T) vaccine sponsors. In such implementations, the third party (not shown) uses vaccine sponsor account database 318 to verify that the account identifier read from flu vaccine prepaid or entitlement card 350 is associated with one of the ‘R’ flu vaccine prepaid or entitlement card sponsors. Vaccine sponsor account database 318 may additionally be used to verify that the associated account contains funds sufficient to reimburse healthcare service provider (m) 310 for the discount applied. In certain implementations, the aforementioned third party (not shown) is the same entity as transaction handler (u) 306. In other implementations, third party (not shown) is a separate entity from transaction handler (u) 306.

When healthcare service provider (m) 310 submits the transaction to a payment processing system 300 via POS (m) 310 for clearing and settlement, the account of flu vaccine sponsor account issuer (t) 312 is debited (e.g.; decreased) for the cost of the vaccine. Specifically, healthcare service provider (m) 310 submits a request for payment to acquirer (s) 308. Where acquirer (s) 308 is not the same entity as flu sponsor account issuer (t) 312, acquirer (s) 308 forwards the request to transaction handler (u) 306. Transaction handler (u) 306 in turn requests payment for the vaccine from flu sponsor account issuer (t) 312, where flu sponsor account issuer (t) 312 is the issuer of the account associated with flu vaccine sponsor. Flu sponsor account issuer (t) 312 debits (decreases) the currency in the account and forward the payment to transaction handler (u) 306 who forwards the payment to acquirer (s) 308. Finally, acquirer (s) 308 credits the account of healthcare service provider (m) 310 with the cost of providing the controlled substance, and its administration, to the patient 302.

In certain implementations, the clearing and settlement process may involve a third party (not shown). In such an implementation, the third party may, by way of example and not limitation, record each flu vaccine prepaid or entitlement card 350 or voucher 352 that has been cleared and settled. This record may be kept in healthcare service provider database 316 or in another separate database 322. Alternatively or in addition to, the third party may verify that the flu vaccine prepaid or entitlement card 350 or voucher 352 was used in the transaction being cleared and settled. In yet other implementations, the third party may determine the account associated with sponsor of the vaccine in order that transaction handler (u) 306 may request flu sponsor account issuer (t) 312 to debit (decrease) the currency in the corresponding account of the sponsor. In such implementations, the third party may access vaccine sponsor account database 318.

As will be understood by a person of ordinary skill in the art, the process described in connection with FIG. 3 is equally applicable to the situation where a patient uses a prepaid or entitlement card having multiple flu vaccines service payments credited or stored thereon such that the prepaid or entitlement card is not a single use card but rather can be used for receiving a plurality of flu shots (e.g.; one flu shot for each member of an employee's family up to eight (8) flu shots). In such a situation, the flu vaccine prepaid or entitlement cards may be provided by different flu vaccine prepaid or entitlement card sponsors having accounts issued by different issuers. For example, card 350 or voucher 352 may show one or more accounts which, when parsed the issuer thereof, will attribute the cost of a controlled substance for the vaccine to one account and the cost of administering the controlled substance (i.e., giving the shot) to yet another and different account). Further, it will be clear to a person of ordinary skill in the art that a prepaid or entitlement flu vaccine card may have multiple different types of flu vaccine shot credits stored thereon that are valid at respectively different healthcare service providers, each having a different acquirer.

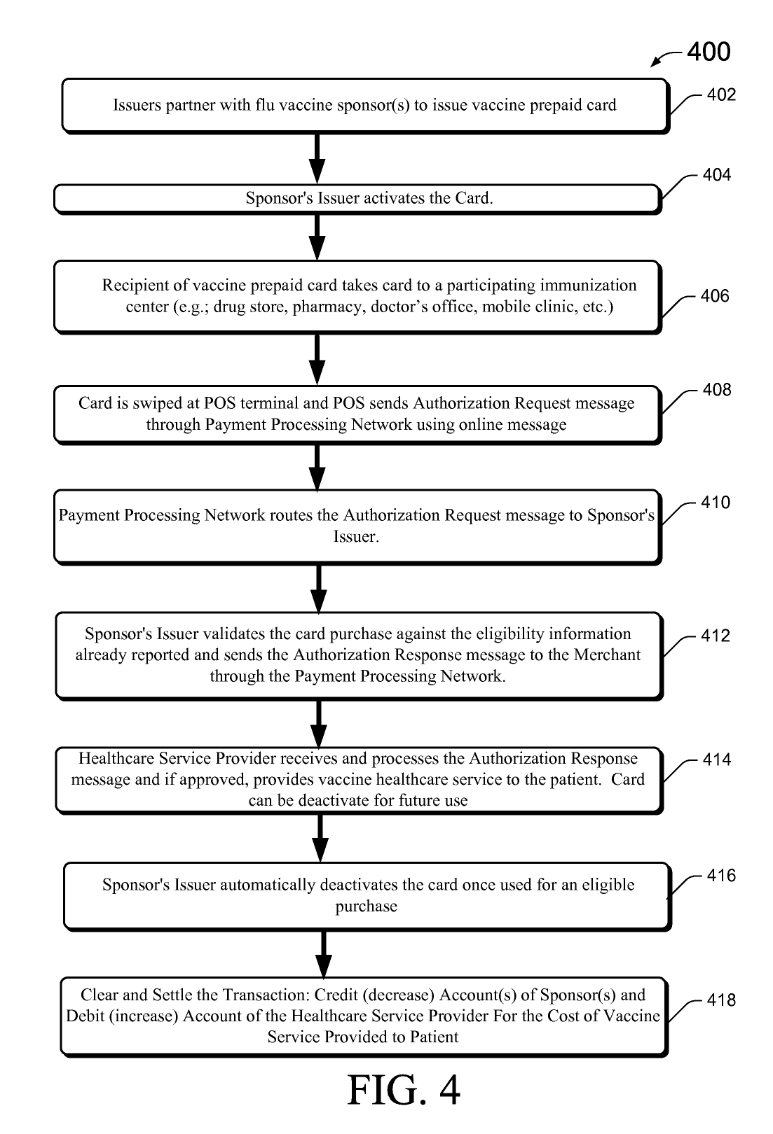

Turning now to FIG. 4, a flow chart of an exemplary method 400 used in a transaction to process an flu vaccine service cost stored on a flu vaccine prepaid or entitlement card is presented. As indicated by block 402, an issuer would partner with businesses, non-profits, and/or government agencies to issue a vaccine prepaid or entitlement card, where each partner would sponsor the cost of the flu vaccines, either the cost of the controlled substance, its administration to patients, or both. The flu vaccine prepaid or entitlement card would be used by patients to obtain a free (or discounted) flu vaccine from participating healthcare service providers, such as retailers with flu shot clinic, doctors, and medical facilities. The flu vaccine prepaid or entitlement card could be a plastic magnetic stripe card to facilitate authorization, clearing, and settlement through a typical merchant POS system and process as would other consumer purchases that are processed through a payment processing network by a consumer's use of a portable payment device (e.g.; an open loop credit/debit/prepaid/entitlement card). At block 404, an issuer of an account issued to a sponsor of the flu vaccine program or campaign would individually, or in bulk, activate the flu vaccine prepaid or entitlement card(s).

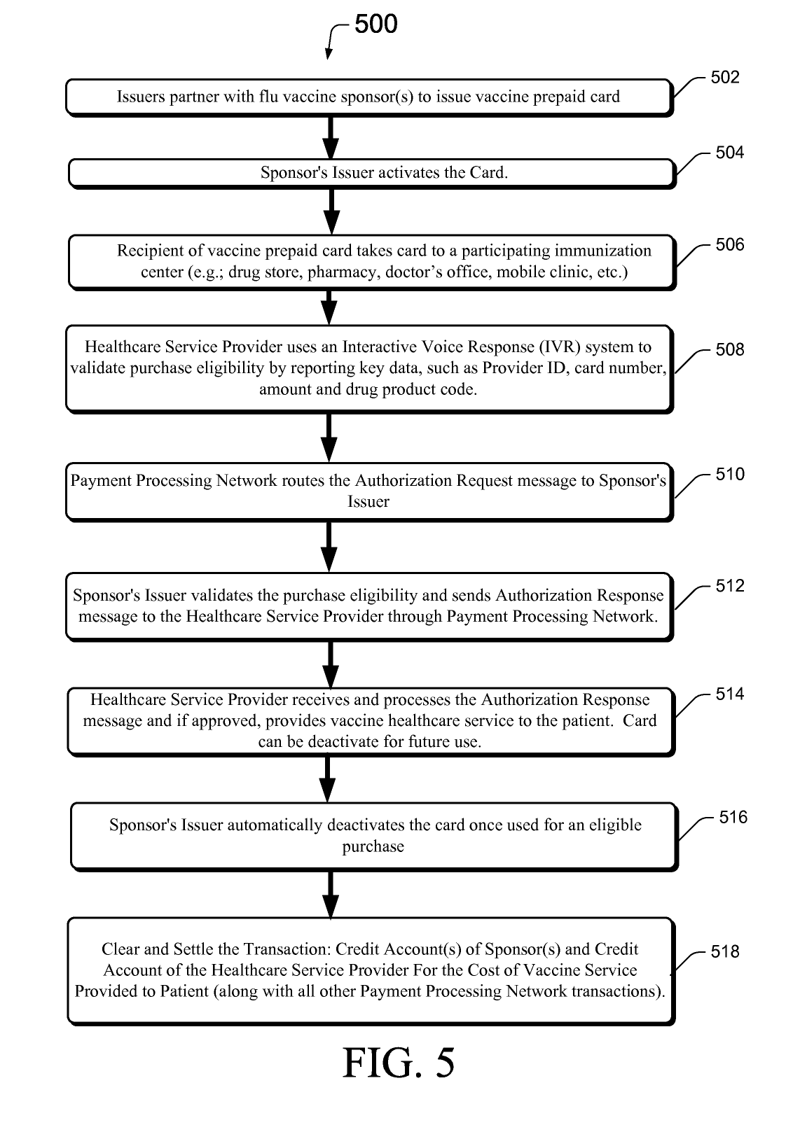

At block 404, a recipient of a flu vaccine prepaid or entitlement card takes the card to a participating immunization center, which could be a drug store, pharmacy, doctor's office, mobile clinic, etc. The healthcare service provider (i.e., merchant) would have two POS processing options, seen respectively in FIGS. 4-5.

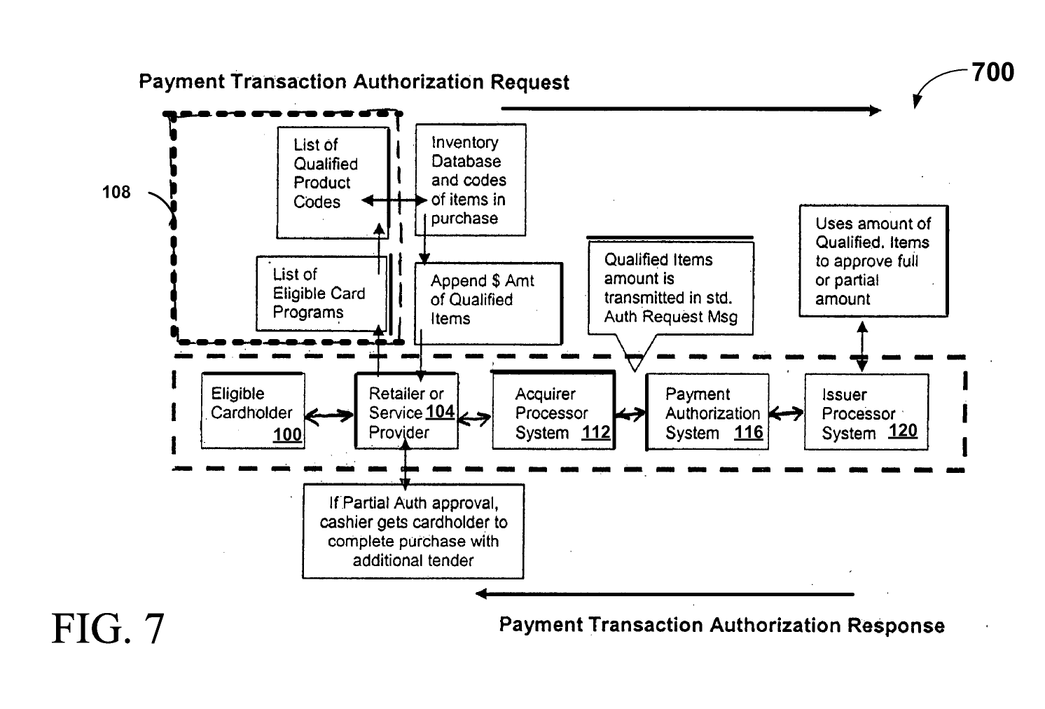

In FIG. 4, product information is captured and eligibility is validated at the POS via an authorization request message sent from the POS. At block 408, the flu vaccine prepaid or entitlement card is swiped at the POS terminal and the POS sends an authorization request message through a payment processing network. Implementations for obtaining an authorization via auto-substantiation processing to assess the cost of the flu vaccine to an account associated with the prepaid or entitlement card are more fully discussed below in conjunction with FIGS. 7 through 18C. At block 410, the payment processing network routes the authorization request message to Sponsor's Issuer, such as via the healthcare provider's acquirer and the transaction handler. In some implementations, blocks 410 in FIG. 4 and block 510 in FIG. 5 include auto-substantiation processing as described below relative to FIGS. 7 through 18C.

At block 412, the flu vaccine sponsor's issuer validates the purchase eligibility and sends an authorization response message to the healthcare service provider (e.g., the merchant) back through the payment processing network via the healthcare provider's acquirer and the transaction handler. At block 414, the healthcare provider receives and processes the authorization response message and if approved, provides the patient with the controlled substance (i.e., vaccine) administered via a shot (or other administration such as by nasal inhalation). At block 416, the sponsor's issuer can automatically deactivates the card or voucher, if spent, once used for an eligible purchase. The healthcare service provider can, in some implementations, automatically receive payment for its vaccine services purchases, along with all other payment processing network transactions (e.g.; via clearing and settlement) as shown at block 418.

In FIG. 5, block 502-506 are similar to step 402-406 in FIG. 4. In block 508 of FIG. 5, a healthcare service provider, rather than using a POS to read a flu vaccine prepaid or entitlement card or voucher, uses an Interactive Voice Response (IVR) system to validate purchase eligibility by reporting key data read from the card or voucher, such as Provider ID, card number, amount and drug product code. At block 510, the payment processing network routes the authorization request message to Sponsor's Issuer, such as via the healthcare provider's acquirer and the transaction handler. At block 512, the flu vaccine sponsor's issuer validates the purchase eligibility and sends an authorization response message to the healthcare service provider (e.g., the merchant) back through the payment processing network via the healthcare provider's acquirer and the transaction handler. At block 514, the healthcare provider receives and processes the authorization response message and if approved, provides the patient with the controlled substance (i.e., vaccine) administered via a shot (or other administration such as by nasal inhalation). At block 516, the sponsor's issuer can automatically deactivates the card or voucher, if spent, once used for an eligible purchase. The healthcare service provider can, in some implementations, automatically receive payment for its vaccine services purchases, along with all other payment processing network transactions (e.g.; via clearing and settlement) as shown at block 518.

In some implementation, a flu vaccine prepaid or entitlement card can be associated with a sponsor's account number that has a Bank Identification Number (BIN) that is assigned by a transaction handler (e.g., by Visa Inc. or other transaction handler). For instance, the account number can begin with the digit ‘4’. In other implementations, the prepaid or entitlement card can have a form factor of a physical plastic card design that may contain a bar code that conveys the vaccine drug product code. In other implementations, the flu vaccine service would not be permitted to be combined, by the patient or healthcare service provider, with the purchase of any other good or service. In still other implementations, a private label service for a payment processing network could be used, such as for the flu vaccine sponsor's issuer or for a specific transaction handler (i.e.; Visa Inc.—VisaNet), who validates that a flu vaccine prepaid or entitlement card is being redeemed from an authorized or participating location and/or healthcare service provider (i.e.; merchant), and that the funds have been set aside with the sponsor's issuer for the vaccine that has not yet been redeemed, and that the flu vaccine prepaid or entitlement card is still valid. The payment processing network clearing and settlement system can be used to move funds between the funding party and the vaccine redemption location (e.g.; the merchant and/or location thereof, administering the flu shot to the patient).

In certain implementations, individual blocks described above for FIGS. 4-5 may be combined, eliminated, or reordered. Also, in certain implementations, instructions (e.g.; software) are encoded in computer readable medium wherein those instructions are executed by computing apparatus (e.g.; hardware) processor to perform one or more of the blocks for FIGS. 4-5. In yet other implementations, instructions reside in any other computer program product, where those instructions are executed by a computer external to, or internal to, a computing system to perform one or more of the blocks of FIGS. 4-5. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compact flash, smart media, and the like.

An Exemplary Transaction Processing System/Payment Processing Network

Referring to FIG. 6, a transaction processing system 600 is seen to as an environment in which methods 400 and 500 in FIGS. 4-5 can be performed, and as a general example for payment processing system 300 in FIG. 3. Transaction processing system 600 is a telecommunications network that may make use of any suitable telecommunications network and may involve different hardware, different software and/or different protocols then those discussed below. Transaction processing system 600 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice-the first time with only information needed for an authorization decision, an again later with additional information for clearing and settlement. A single message transaction is sent once for authorization and contains clearing and settlement information as well. Typically, authorization, clearing and settlement all occur on-line.

The general environment of FIG. 6 include that of a merchant (m) 610, such as the merchant, who can conduct a transaction for goods and/or services with an account user (au) (e.g., consumer) on an account issued to an account holder (a) 608 by an issuer (i) 604, where the processes of paying and being paid for the transaction are coordinated by at least one transaction handler (th) 602 (e.g., the transaction handler) (collectively “users”). The transaction includes participation from different entities that are each a component of the transaction processing system 600.

The transaction processing system 600 may have at least one of a plurality of transaction handlers (th) 602 that includes transaction handler (1) 602 through transaction handler (TH) 602, where TH can be up to and greater than an eight digit integer.

The transaction processing system 600 has a plurality of merchants (m) 610 that includes merchant (1) 610 through merchant (M) 610, where M can be up to and greater than an eight digit integer. Merchant (m) 610 may be a person or entity that sells goods and/or services. Merchant (m) 610 may also be, for instance, a healthcare service provider who can administer a controlled substance (e.g.; a drug) to a patient in the form of a vaccine, such as flu shot or a nasal inhalation procedure. In a business-to-business setting, the account holder (a) 608 may be a second merchant (m) 610 making a purchase from another merchant (m) 610.

Transaction processing system 600 includes account user (1) 608 through account user (AU) 608, where AU can be as large as a ten digit integer or larger. Each account user (au) conducts a transaction with merchant (m) 610 for goods and/or services using the account that has been issued by an issuer (i) 604 to a corresponding account holder (a) 608. Data from the transaction on the account is collected by the merchant (m) 610 and forwarded to a corresponding acquirer (a) 606. Acquirer (a) 606 forwards the data to transaction handler (th) 602 who facilitates payment for the transaction from the account issued by the issuer (i) 604 to account holder (a) 608.

Transaction processing system 600 has a plurality of acquirers (q) 606. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger.

The transaction handler (th) 602 may process a plurality of transactions within the transaction processing system 600. The transaction handler (th) 602 can include one or a plurality or networks and switches (ns) 602. Each network/switch (ns) 602 can be a mainframe computer in a geographic location different than each other network/switch (ns) 602, where ‘ns’ is an integer from one to NS, and where NS can be as large as a four digit integer or larger.

Dedicated communication systems 620, 622 (e.g., private communication network(s)) facilitate communication between the transaction handler (th) 602 and each issuer (i) 604 and each acquirer (a) 606. A Network 612, via e-mail, the World Wide Web, cellular telephony, and/or other optionally public and private communications systems, can facilitate communications 622a-622e among and between each issuer (i) 604, each acquirer (a) 606, each merchant (m) 610, each account holder (a) 608, and the transaction handler (th) 602. Alternatively and optionally, one or more dedicated communication systems 624, 626, and 628 can facilitate respective communications between each acquirer (a) 606 and each merchant (m) 610, each merchant (m) and each account holder (a) 608, and each account holder (a) 608 and each issuer (i) 604, respectively.

The Network 612 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 612 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 612 may utilize any of a variety of communication protocols, such as Transmission Control Protocol/Internet Protocol (TCP/IP), for example. There may be multiple nodes within the network 612, each of which may conduct some level of processing on the data transmitted within the transaction processing system 600.

Users of the transaction processing system 600 may interact with one another or receive data about one another within the transaction processing system 600 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 600 by the account holder (a) 608 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, prepaid card, entitlement card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof. The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 608's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 610 may utilize at least one POI terminal (e.g., Point of Service or browser enabled consumer cellular telephone); that can communicate with the account user (au) 608, the acquirer (a) 606, the transaction handler (th) 602, or the issuer (i) 604. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 610 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 600.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 610. These data can include an account identifier of a healthcare account. In another example, the POI may be the PCD of the consumer, such as the cellular telephone of the consumer, where the merchant (m) 610, or an agent thereof, receives the account identifier of the consumer via a webpage of an interactive website rendered by a browser executing on a World Wide Web (Web) enabled PCD.

Typically, a transaction begins with account user (au) 608 presenting the portable consumer device to the merchant (m) 610 to initiate an exchange for resources (e.g., a good or service). The portable consumer device may be associated with an account (e.g., a credit account) of account holder (a) 608 that was issued to the account holder (a) 608 by issuer (i) 604.

Merchant (m) 610 may use the POI terminal to obtain account information, such as a number of the account of the account holder (a) 608, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 604 of the account associated with the PCD. Alternatively, or in combination, the PCD may communicate with issuer (i) 604, transaction handler (th) 602, or acquirer (a) 606.

Issuer (i) 604 may authorize the transaction and forward same to the transaction handler (th) 602. Transaction handler (th) 602 may also clear the transaction. Authorization includes issuer (i) 604, or transaction handler (th) 602 on behalf of issuer (i) 604, authorizing the transaction in connection with issuer (i) 604's instructions such as through the use of business rules. The business rules could include instructions or guidelines from the transaction handler (th) 602, the account holder (a) 608, the merchant (m) 610, the acquirer (a) 606, the issuer (i) 604, a related financial institution, or combinations thereof. The transaction handler (th) 602 may, but need not, maintain a log or history of authorized transactions. Once approved, the merchant (m) 610 may record the authorization, allowing the account user (au) 608 to receive the good or service from merchant (m) or an agent thereof.

The merchant (m) 610 may, at discrete periods, such as the end of the day, submit a list of authorized transactions to the acquirer (a) 606 or other transaction related data for processing through the transaction processing system 600. The transaction handler (th) 602 may optionally compare the submitted authorized transaction list with its own log of authorized transactions. The transaction handler (th) 602 may route authorization transaction amount requests from the corresponding the acquirer (a) 606 to the corresponding issuer (i) 604 involved in each transaction. Once the acquirer (a) 606 receives the payment of the authorized transaction from the issuer (i) 604, the acquirer (a) 606 can forward the payment to the merchant (m) 610 less any transaction costs, such as fees for the processing of the transaction. If the transaction involves a debit or pre-paid card, the acquirer (a) 606 may choose not to wait for the issuer (i) 604 to forward the payment prior to paying merchant (m) 610.

There may be intermittent steps in the foregoing process, some of which may occur simultaneously. For example, the acquirer (a) 606 can initiate the clearing and settling process, which can result in payment to the acquirer (a) 606 for the amount of the transaction. The acquirer (a) 606 may request from the transaction handler (th) 602 that the transaction be cleared and settled. Clearing includes the exchange of financial information between the issuer (i) 604 and the acquirer (a) 606 and settlement includes the exchange of funds. The transaction handler (th) 602 can provide services in connection with settlement of the transaction. The settlement of a transaction includes depositing an amount of the transaction settlement from a settlement house, such as a settlement bank, which transaction handler (th) 602 typically chooses, into a clearinghouse bank, such as a clearing bank, that acquirer (a) 606 typically chooses. The issuer (i) 604 deposits the same from a clearinghouse bank, such as a clearing bank, which the issuer (i) 604 typically chooses, into the settlement house. Thus, a typical transaction involves various entities to request, authorize, and fulfill processing the transaction.

The transaction processing system 600 will preferably have network components suitable for scaling the number and data payload size of transactions that can be authorized, cleared and settled in both real time and batch processing. These include hardware, software, data elements, and storage network devices for the same. Examples of transaction processing system 600 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 602 can include one or more data centers for processing transactions, where each transaction can include up to 100 kilobytes of data or more. The data corresponding to the transaction can include information about the types and quantities of goods and services in the transaction, information about the account holder (a) 608, the account user (au) 608, the merchant (m) 610, tax and incentive treatment(s) of the goods and services, coupons, rebates, rewards, loyalty, discounts, returns, exchanges, cash-back transactions, etc.

By way of example, network/switch (ns) 602 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 604 (or agent issuer (ai) 604 thereof) and each acquirer (a) 606 (or agent acquirer (aq) 606 thereof) can use or more router/switch (e.g., Cisco™ routers/switches) to communicate with each network/switch (ns) 602 via dedicated communication systems.

Transaction handler (th) 602 can store information about transactions processed through transaction processing system 600 in data warehouses such as may be incorporated as part of the plurality of networks/switches 602. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 600 over paying and being paid by cash, or other traditional payment mechanisms.

FIG. 6 includes transaction handler (th) 602 communicating through access points 630, 632 with acquirers 606, and issuers 604. Other entities such as drawee banks and third party authorizing agents may also connect to the network through access points 630, 632. Access points 630, 632 are typically made up of small computer systems located at a processing center that interfaces between the center's host computer and an interchange center. The access point facilitates the transmission of messages and files between the host and the interchange center supporting the authorization, clearing and settlement of transaction. Telecommunication links between the acquirer (q) 606 and its access point 632, and between the access point 630 and issuer (i) 604, are typically local links within a center and use a proprietary message format as preferred by the center.

As mentioned above, access points 630, 632 are typically located at a data processing center that interfaces between the data processing center's host computer and an interchange center. The interchange center is a data processing center that may be located anywhere in the world. In one implementation, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (Transaction Handler 402) to remote entities use dedicated high-bandwidth telephone circuits or satellite connections based on the IBM SNA-LU0 communication protocol. Messages are sent over these lines using any suitable implementation of the ISO 8583 standard.

A data processing center (such as is located within an acquirer, issuer, or other entity) houses processing systems that support merchant and business locations and maintains customer data and billing systems. Preferably, each data processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

The VisaNet® system is an example component of the transaction handler (th) 602 in the transaction processing system 600. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 30 million merchants (m) 610. In 2007, around 81 billion transactions for about 4 trillion U.S. dollars were cleared and settled through the VisaNet® system, some of which involved a communication length of around 24,000 miles in around two (2) seconds and during which a plurality of stops are made for processing data in the transaction.

Referring now to FIG. 7, a flow diagram is shown that illustrates a method of implementing a payment transaction authorization request and payment transaction authorization response for a flu vaccine sponsor account. FIG. 7 shows a system that can be used for processing transactions that are initiated at a healthcare provider location, for example, at a pharmacy or drug store. Advantageously, a consumer can use a flu vaccine sponsor account a retailer or healthcare service provider in an over-the-counter fashion because a substantial number of the Point of Service terminals (POS) used by the same are now, or will be in the future, configured to perform auto-substantiation of items purchases over the counter in such transactions. Thus, flu vaccine goods or services can be purchased in transactions on the flu vaccine sponsor accounts without modification of many such POS installation, and without undergoing the timely process of submitting receipts and additional paperwork to verify that the purchase was made and was made for an item that was qualified under the flu vaccine sponsor account. Therefore, FIG. 7 illustrates a system that provides an auto substantiation function by determining whether a flu vaccine good or service is a qualified purchase under a flu vaccine sponsor account so as to be entitled to be purchased with a flu vaccine sponsor account prepaid or entitlement card, for example.

FIG. 7 at reference numeral 700 shows a flu vaccine coupon prepaid or entitlement card holder 100 requesting a flu vaccine for purchase at a retailer or service provider 104. The retailer's electronic cash register system (e.g.; POS) support supports a list of qualified products and services for purchase on various types and kinds of accounts (e.g.; coupon sponsor accounts). For example, the POS supports a flu vaccine being purchased upon a flu vaccine sponsor account that is encoded on a prepaid or entitlement card. The support at the POS can be facilitated, for example, by assess to a list of qualified product codes. This list of qualified product codes establishes a list of qualified product categories that are eligible for card usage. For instance, the list may include qualified product codes for qualified flu vaccines that are eligible for flu vaccine sponsor account prepaid or entitlement card usage. Additionally, the electronic cash register can support a list of identifying flu vaccine prepaid or entitlement card programs. For example, the first six digits of the flu vaccine sponsor account prepaid or entitlement card number can be utilized to identify the account as being a flu vaccine sponsor account that is eligible for purchase of a flu vaccine from that particular merchant. Thus, FIG. 7 illustrates the electronic cash register 108 as storing the list of codes and eligible card programs. An electronic cash register system, or POS, is a term used to describe both integrated systems where terminal functionality is built within the cash register itself as well as systems where the POS terminal is a stand-alone device that interacts with the electronic cash register.

When a consumer presents an eligible flu vaccine sponsor account prepaid or entitlement card, the healthcare service provider can match the flu vaccine sponsor account prepaid or entitlement card number with the list of eligible card programs. Upon identifying an eligible card program, the healthcare provider's electronic cash register system can evaluate the requested flu vaccine inventory code in the checkout basket against the list of qualified product categories. It should be understood that the flu vaccine sponsor account prepaid or entitlement card is a type of payment card such as a portable consumer transaction device. Examples of portable consumer transaction devices include credit cards, debit cards, prepaid cards, entitlement cards, healthcare insurance cards, smart cards (integrated circuit chip cards), contactless chip cards (using radio frequency identification), driver's licenses, personal digital assistants, ATM cards, security badges, access badges, stored value cards, biometric identification cards, pagers, and the like. Interaction between a retailer's electronic cash register system or POS terminals and the portable consumer device can be facilitated using any suitable optical, magnetic, electromagnetic, or electronic mechanism. In some embodiments, the portable consumer device is in the form of a card and has a magnetic stripe.

Upon determining that the product code for the flu vaccine for purchase matches one of the qualified product codes in the list accessible from the electronic cash register and that the flu vaccine sponsor account identifier provided by the consumer who is holding the prepaid or entitlement card matches one of the eligible card programs in the list of eligible card programs that is accessible from the electronic cash register, an authorization request message is formatted by the retailer 104 (e.g.; by the POS of the merchant-healthcare provider). This authorization request message is sent to the retailer's acquirer processor system 112 in FIG. 7. Furthermore, FIG. 7 shows that the acquirer processor system forwards the authorization request message to the payment authorization system 116 which in turn forwards the authorization request message to the issuer processor system 120. The issuer processor system 120 (e.g.; a system correlated to the issuer of the flu vaccine sponsor account) or a third party can review the authorization request message so as to determine whether the purchase is authorized under the flu vaccine sponsor account. This can be accomplished by reviewing the cost of the flu vaccine or by reviewing a product code and product amount for the flu vaccine that was submitted as part of the authorization request message.

Once the determination is made by the issuer of the sponsor account or its associated third party (such as a third party administrator or end user client of the issuer), a payment transaction authorization response message can be formatted. This is returned to the healthcare service provider-merchant (e.g.; a retailer or service provider). One alternative is for partial authorization to be granted for an entire transaction to be assess upon a flu vaccine sponsor account, where the transaction is for several goods and services only one of which is a flu vaccine. In such cases, there can be a denying authorization for the balance of the purchase amount over and above the cost of the flu vaccine. In that situation, the retailer can request additional payment means from the consumer who presented the flu vaccine prepaid or entitlement card. Thus, a purchase of an authorized product (e.g.; a flu vaccine) can be made with the flu vaccine sponsor account prepaid or entitlement card while cash, check, or other payment card is used to pay for non-authorized products.

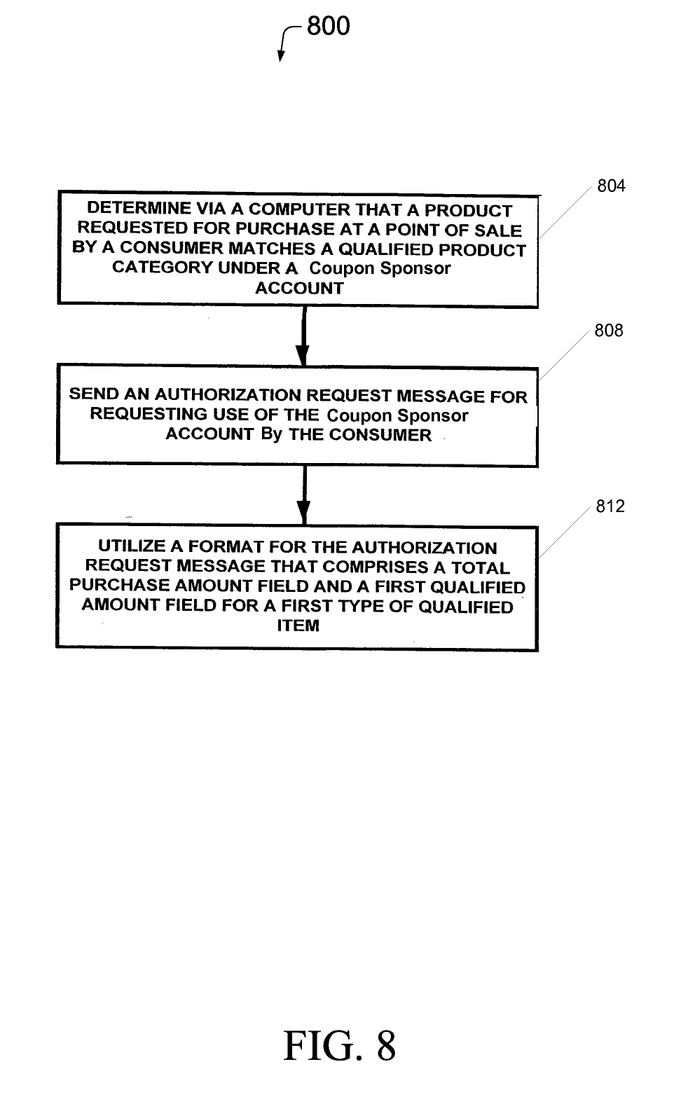

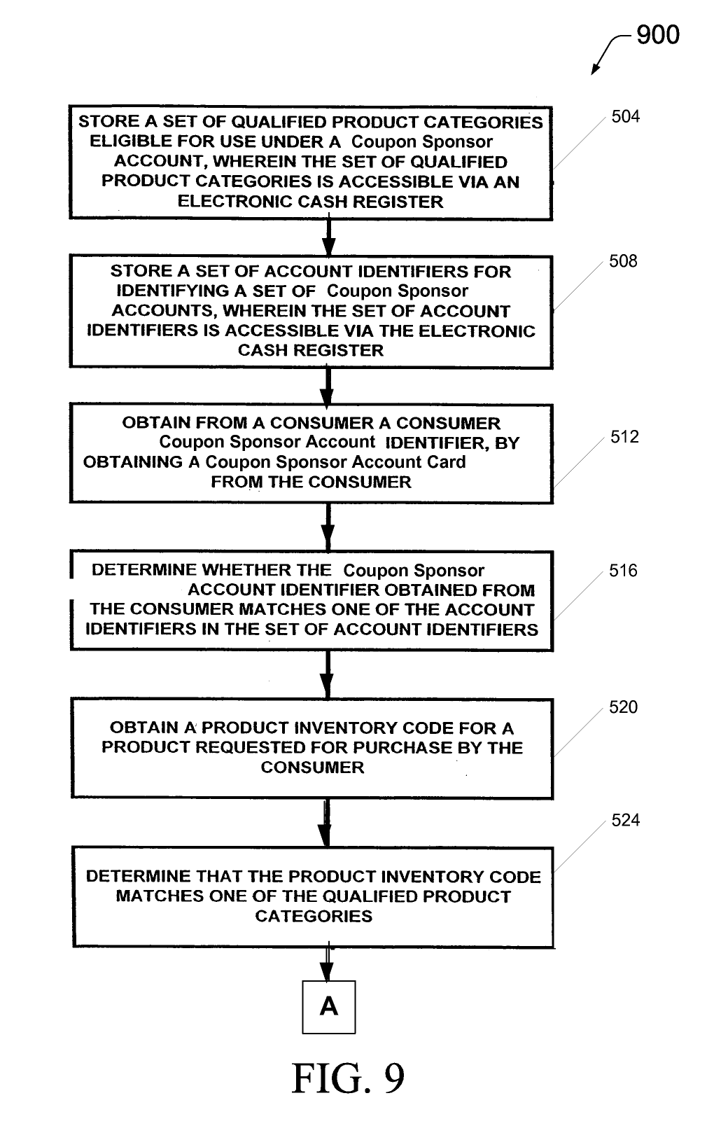

Referring now to FIG. 8, a flow chart 800 illustrates a method of conducting the authorization transaction according to one embodiment of the invention is shown. In block 804, a determination is made via a computer that a flu vaccine requested for purchase at a point of sale by a consumer matches a qualified product category under a flu vaccine sponsor account encoded on a flu vaccine sponsor account prepaid or entitlement card. It should be understood that use of the word “product” is intended to mean not only goods, but also services. In block 808, an authorization request message is sent for requesting use of the flu vaccine sponsor account of the prepaid or entitlement card presented by the consumer. In block 812 a format for the authorization request message is utilized that comprises a total purchase amount field, as well as a first qualified amount field for a first type of qualified item(s). This amount field can include the total purchase price for one or more qualified items. A more detailed method according to one embodiment of the invention can be seen in FIGS. 9-11.

FIGS. 9-11 illustrate a flowchart that demonstrates a method of conducting a transaction according to the system shown in FIGS. 3 and 7. Referring now to FIG. 9 at reference numeral 900, in block 504, a set of qualified product categories are stored that correspond to flu vaccines that are eligible for use under a flu vaccine sponsor account. For example, these can be stored in the memory of an electronic cash register or in a data storage device which is accessible by the merchant utilizing the electronic cash register. Thus, it is not required that the qualified product categories be stored at the electronic cash register or merchant processing device as long as they are accessible to the merchant. In block 508 a set of account identifiers for identifying a set of flu vaccine sponsor accounts is stored. Again, these can be stored at the electronic cash register or at a different storage location.

In block 512 the consumer presents a flu vaccine sponsor account prepaid or entitlement card. The prepaid or entitlement card encodes an identifier a flu vaccine sponsor account upon which a transaction is to be conducted for the purchase of a flu vaccine. The merchant obtain the flu vaccine sponsor account identifier from the prepaid or entitlement card presented by the consumer. In block 516 a determination is made as to whether the flu vaccine sponsor account identifier matches one of the account identifiers in the list accessible from the electronic cash register. The list of valid account identifiers can include not only the flu vaccine sponsor account identifier, but also those identifiers used for healthcare related goods and services being sponsored by other sponsors. One way to implement this is by utilizing the first six digits of an account identifier for purposes of identifying all the flu vaccine sponsor accounts associated with a certain plan. Thus, for example, the bank identification numbers (BIN) utilized by Visa on its payment cards can be grouped via the first six numbers of those bank identification numbers to indicate participation in a particular flu vaccine sponsor account program. Individuals participating in a particular flu vaccine sponsor account plan can be identified particularly by the remaining numbers in the bank identification number. This provides an efficient way to identify a flu vaccine sponsor account prepaid or entitlement card without requiring storage of all flu vaccine sponsor account bank identification numbers at the electronic cash register. Additional flu vaccine sponsor account programs accepted by the merchant can be recognized by the first six digits of their respective BIN numbers, as well.

In block 520 of FIG. 9, a product inventory code is obtained for the particular flu vaccine requested for purchase by the consumer. For example, the Stock Keeping Unit (SKU) (i.e., or other identifier such as a National Drug Code, a Universal Product Code (UPC), or a Globally Unique Identifier (GUID)) for a flu vaccine can be obtained by scanning a barcode on packaging containing a syringe for the requested flu vaccine or entering the SKU for the flu vaccine being purchased from the healthcare provider. In block 524 a determination is made as to whether the product inventory code matches one of the qualified product categories. By utilizing SKU codes, a simple table look-up can be implemented to determine whether the SKU for a particular product matches one of the product inventory codes stored at the electronic cash register or accessed via the electronic cash register. If the product matches a qualified product category and the card identifier matches a valid account identifier, a payment network authorization request message can be sent with additional information regarding the amount of the qualified items included in the authorization request.

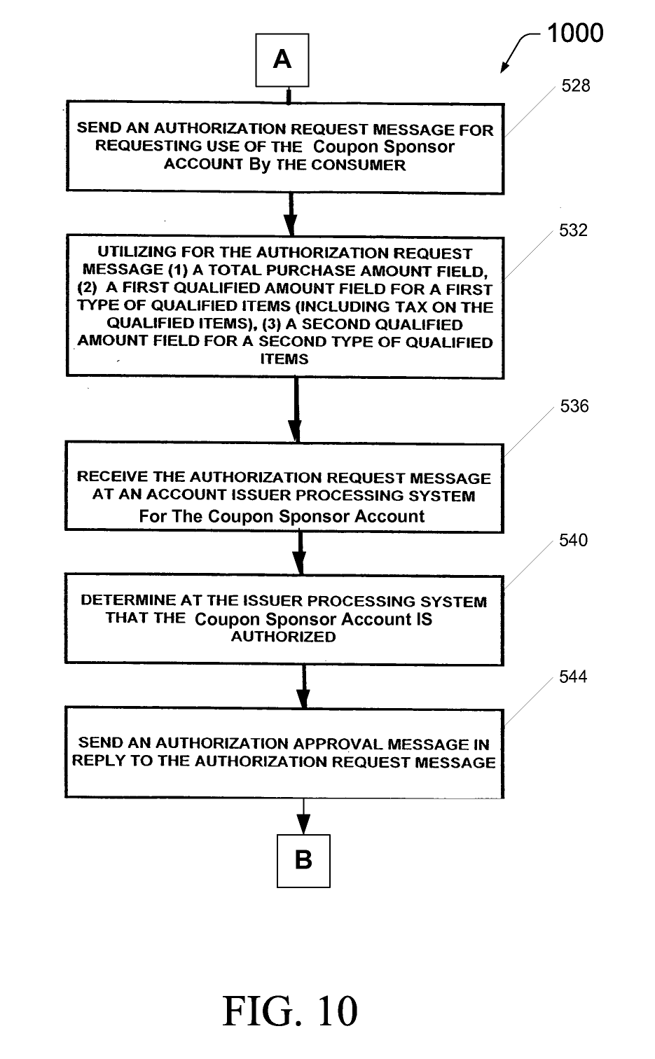

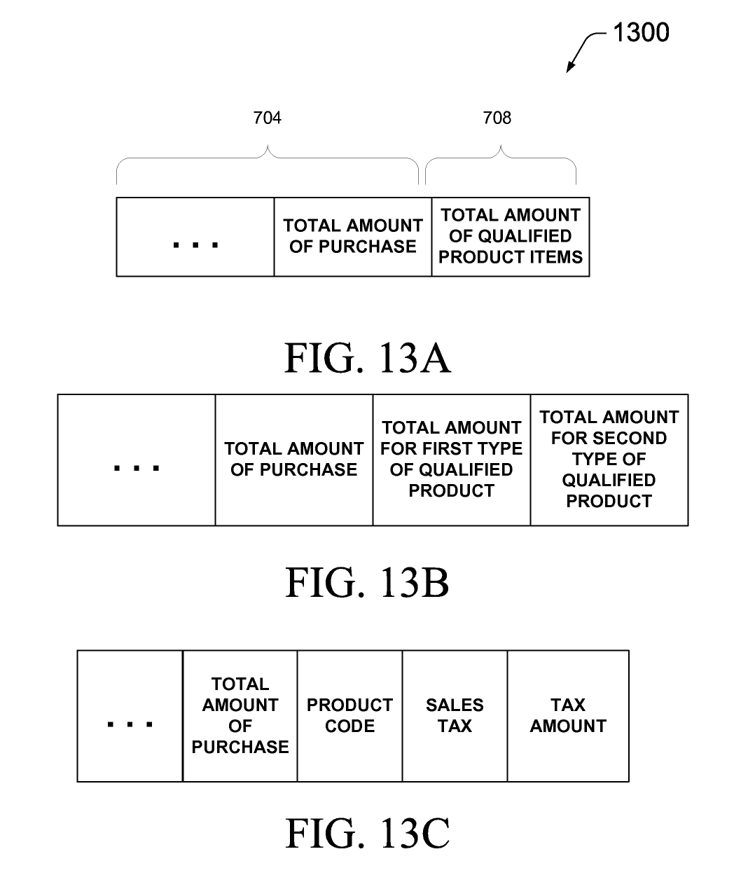

Referring now to FIG. 10 at reference numeral 1000 at leader “A”, in block 528 an authorization request message is sent requesting use of the flu vaccine sponsor account encoded on the prepaid or entitlement card presented by the patient or consumer. The authorization request message can be formatted in a variety of ways. For example, FIGS. 13A-13C illustrate alternative ways of formatting an authorization request for a product being purchased by a transaction conducted on a flu vaccine sponsor account. One example is that shown in block 532 which involves utilizing for the authorization request message the following fields: total purchase amount field; first qualified amount field for a first type of qualified item(s) (including tax on the qualified item(s)); second qualified amount field for a second type of qualified item(s). This format allows an authorization request to be made for a purchase of products that fall into different categories. For example, this could include a first product that falls into a swine flu vaccine reimbursement category and a second product that falls into a H1N1 flu vaccine category. This format is shown in more detail in FIG. 13B.

FIG. 13B illustrates that a standard authorization request message can be formatted with normal fields including the total amount of purchase as well as additional fields for the total amount for the first type of qualified product and the total amount for the second type of qualified product. FIGS. 13A and 13C show alternative embodiments of formatting an authorization request message.

FIG. 13A illustrates that a standard authorization request message 704 can have appended to it a field 708 for the total amount of qualified product items that is being submitted as part of the authorization request. Thus, FIG. 13A illustrates an authorization request message that would be implemented based upon price. By virtue of the electronic cash register determining that the product(s) was a qualified product from the list of qualified products, the initial eligibility test would have been implemented by the electronic cash register.

Alternatively, FIG. 13C illustrates an authorization request message that includes product information. Thus, FIG. 13C shows a standard authorization request message having the total amount of purchase field, as well as appended fields for the product code, sales amount, and tax amount. This information could be forwarded to the issuer or third party administrator working on behalf of the issuer, or the client of the issuer to determine whether the submitted product and the amount of the submitted product qualified under the flu vaccine sponsor account for authorization.

Referring again to FIG. 10, at reference numeral 1000, block 536 shows that the authorization request message is received at an account issuer processing system (e.g.; a system associated with the issuer of the sponsor account from which the cost of the flu vaccine is to be reimbursed). Thus, for example, the authorization request message can be sent via the acquirer of the healthcare provider (i.e., the merchant) and the transaction processing system to the issuer. In block 540 a determination is made as to whether the flu vaccine is authorized to be assessed against the sponsor account in the transaction. The determination can be made by the issuer of the flu vaccine sponsor account. Alternatively, a third party, such as a processor or third party administrator who works for the issuer of the sponsor account can be tasked with the job of determining whether the submitted authorization request qualifies under the flu vaccine sponsor account guidelines. Furthermore, the sponsor to whom the issuer issued the sponsor account, such as the patient's employer or the patient's insurance company, can perform the task as well. Also, a determination can be made, by the issuer, for example, as to whether the flu vaccine sponsor account contains a sufficient funds to pay for the flu vaccine. Once a determination is made in regard to the authorization request, an authorization approval message can be formatted to reply to the authorization request message as shown in block 544.

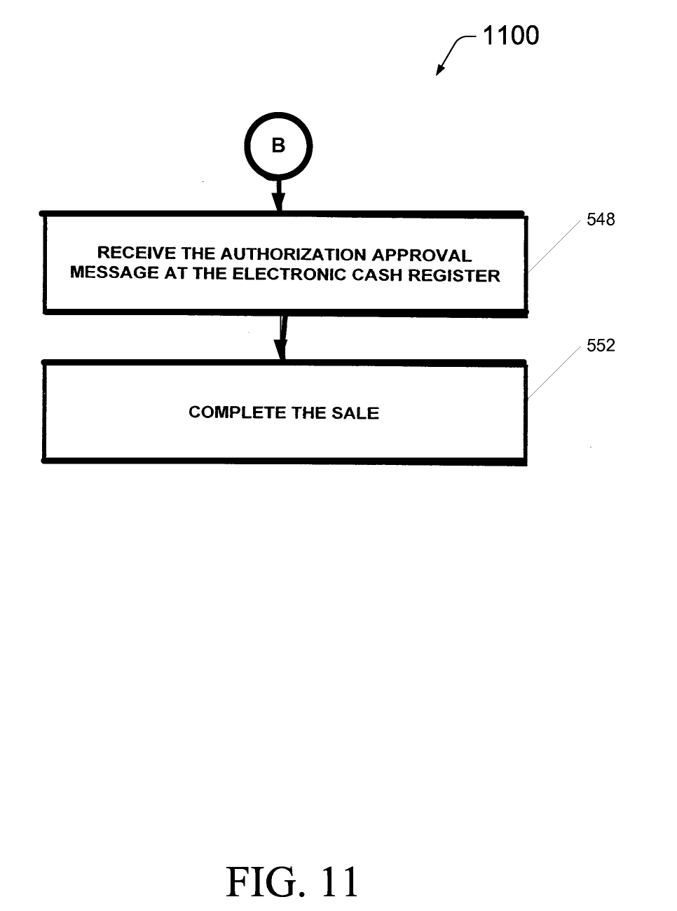

In block 548 of FIG. 11 at reference numeral 1100 at block “B”, the authorization approval message is received at the healthcare service provider, such as at the electronic cash register or POS of the merchant, at which point the sale can be completed as shown in block 552.

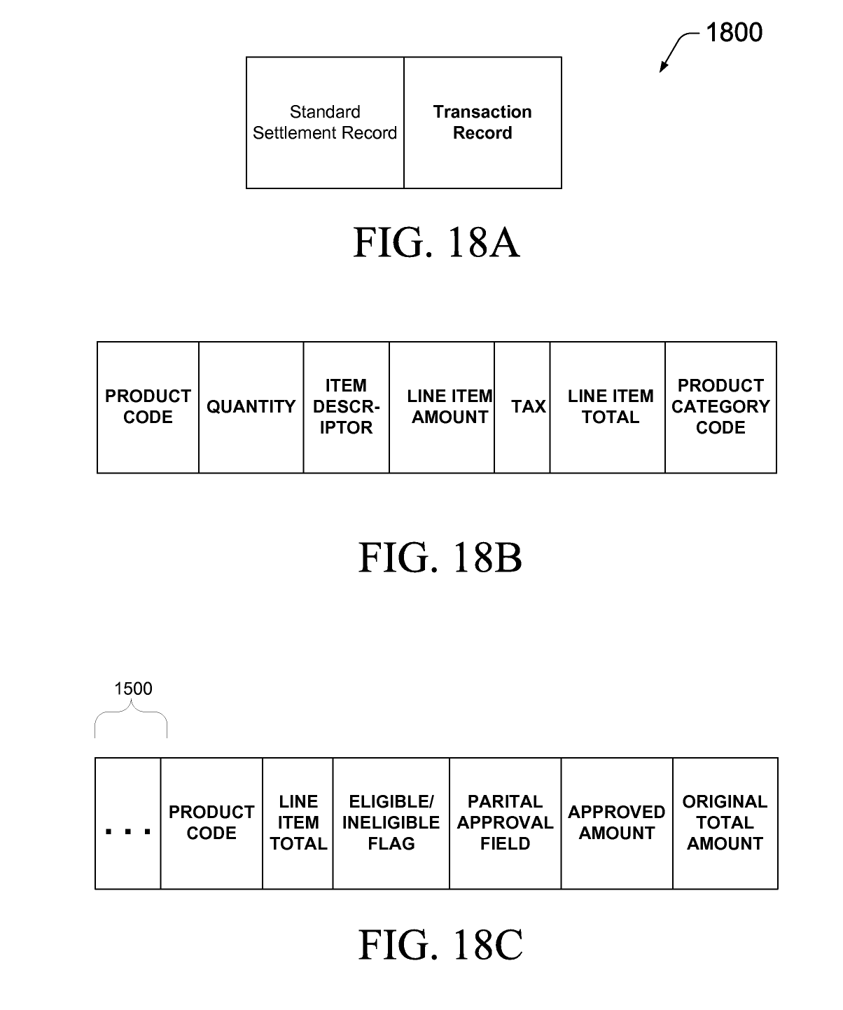

The authorization approval message can be formatted according to FIG. 18C. FIG. 18C shows a standard payment network authorization approval message with additional appended fields. Namely, a product code field for identifying the product submitted for authorization is shown. Also, a line item total for the particular product is shown. Furthermore, a flag indicating whether the product category was eligible or ineligible is shown. In addition, a partial approval field can be utilized to indicate whether total approval is given for use of the flu vaccine sponsor account being utilized to fund the transaction or whether only partial approval is given for the particular product being submitted. In addition, a field indicating the approved amount can be used. Also, the original total amount of the transaction can be appended as well.

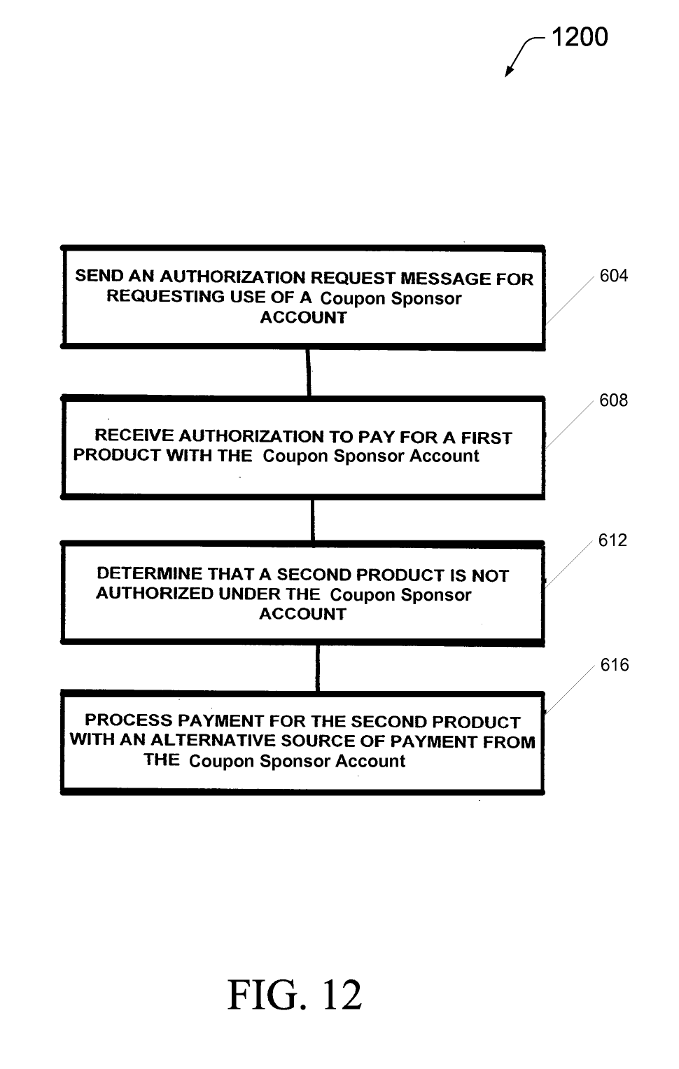

As noted in FIG. 18C, partial approval can be given through the authorization response. This is beneficial in that it allows a transaction to be implemented for the entire purchase amount using the flu vaccine sponsor account and then allows a split tender transaction to be implemented for the balance of the transaction amount that was not authorized in the authorization response. Thus, FIG. 12 illustrates a flow chart demonstrating a method of implementing such a split tender transaction. Namely at reference numeral 1200 of FIG. 12, in block 604, the authorization request message is sent requesting use of the flu vaccine sponsor account. In block 608, authorization is received to pay for a first product (the requested flu vaccine) with the flu vaccine sponsor account. Thus, this would be a flu vaccine that satisfied the regulations of the flu vaccine sponsor account and was considered an approved flu vaccine under the guidelines of that particular flu vaccine sponsor account. In block 612 a determination is made that a second product submitted as part of the same purchase transaction is not authorized under the flu vaccine sponsor account. Thus, for example, if the consumer is also purchasing a candy bar, that would not satisfy the requirements of the flu vaccine sponsor account. As a result, the authorization response message returned by the issuer would indicate that the entire transaction purchase amount was not authorized. Rather, only the price of the flu vaccine (e.g.; the first product) would be authorized. In block 616, a split tender payment process can be implemented by paying for the second product (i.e.; the candy bar) with an alternative source of payment other than the flu vaccine sponsor account. Thus, the patient or consumer could present another payment card, as well as also tending cash or check, for completing the purchase transaction. This provides a benefit in that it allows the consumer to utilize his or her flu vaccine sponsor account payment card and then complete the remainder of the purchase with an alternative form of payment. Further, the method supports an issuer authorization of a partial amount of the qualified total if the cardholder does not have a sufficient available balance to approve the full qualified total amount. This provides the benefit of permitting the cardholder to complete the purchase with spilt tender, using cash, checks or another payment card.

Once an authorization request message has been submitted and an authorization approval message has been received, the transaction still needs to be settled. Thus, a settlement function is typically implemented by a batch process by a merchant in submitting all the transactions for all payments accepted periodically, such as at the end of the day. For example, merchant ABC may submit all the records of the transactions that were made by sending a batch message to the merchant's acquiring bank at the end of the day. The merchant's acquiring bank would then submit all authorized transactions to the respective payment network. Thus, this provides a unique vehicle for forwarding transaction information for use in auditing the transactions made with a flu vaccine sponsor account.

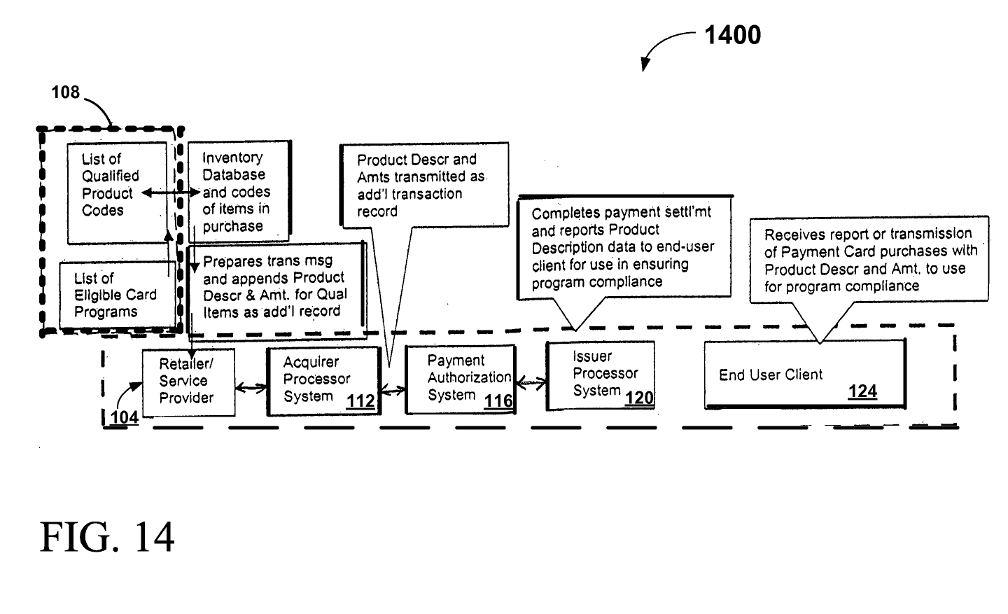

Referring now to FIG. 14, a flow diagram illustrates a method 1400 of confirming program compliance is shown. A payment network settlement transaction can be utilized according to one implementation to include additional data that provides an issuer of a sponsor account, or the sponsor, with information about the particular flu vaccines that were purchased via one or more transactions conducted upon the flu vaccine sponsor account. Thus, FIG. 14 illustrates how a healthcare service provider (i.e.; the merchant) can format a batch process to send to its acquiring bank about all the transactions that conducted upon flu vaccine sponsor accounts administered by participating sponsor account issuers or sponsors. Furthermore, FIG. 14 illustrates that the payment network settlement process can be utilized to send information to the sponsor account issuer or sponsor about particular flu vaccine sponsor account transactions that were made so as to allow the sponsor account issuer or sponsor to confirm that each transaction that was approved by amount, for example, was actually a flu vaccine authorized under the flu vaccine sponsor account.

FIG. 14 shows that a standard settlement record can be appended with product description and amount information for qualified items purchased under the flu vaccine sponsor account. This can be formatted by the retailer 104 as part of the settlement transaction process. The retailer can forward the standard payment network settlement record and the additional information record about the flu vaccine sponsor account transactions (referred to herein as the transaction records) to the acquirer processor system 112 which in turn, forwards it to the payment authorization system 116. The standard payment network settlement record and the appended transaction record can then be forwarded to the issuer processor system 120. At this point the standard payment network settlement record can be utilized by the issuer as part of the settlement process and the transaction record can be separately used by the issuer or forwarded to a third party administrator or end user client. The transaction record can be utilized, for example, by the end user client (i.e.; the sponsor of a flu vaccine program) to check program compliance. As noted earlier, one method of implementing the authorization request is for the merchant to perform a check as to whether a particular product is eligible for purchase on a flu vaccine sponsor account by comparing a product code of the flu vaccine being purchased with a list of product codes accessible via the electronic cash register. The issuer of the flu vaccine sponsor account then approves the amount of the purchase. Thus, the authorization request system according to this implementation is dependent upon the check made by the electronic cash register. The compliance system shown in FIG. 14 allows a program compliance check to be made by the sponsor by retrieving additional information, such as product code and description to confirm that a particular flu vaccine is a qualified product under the guidelines of the flu vaccine sponsor's program, and thus eligible to be charged to a particular flu vaccine sponsor account. It is noted that receiving qualified product amounts in payment network authorization messages may be used on a stand-alone basis or in conjunction with receiving product line item detail transaction records in payment network settlement records, and vice versa.

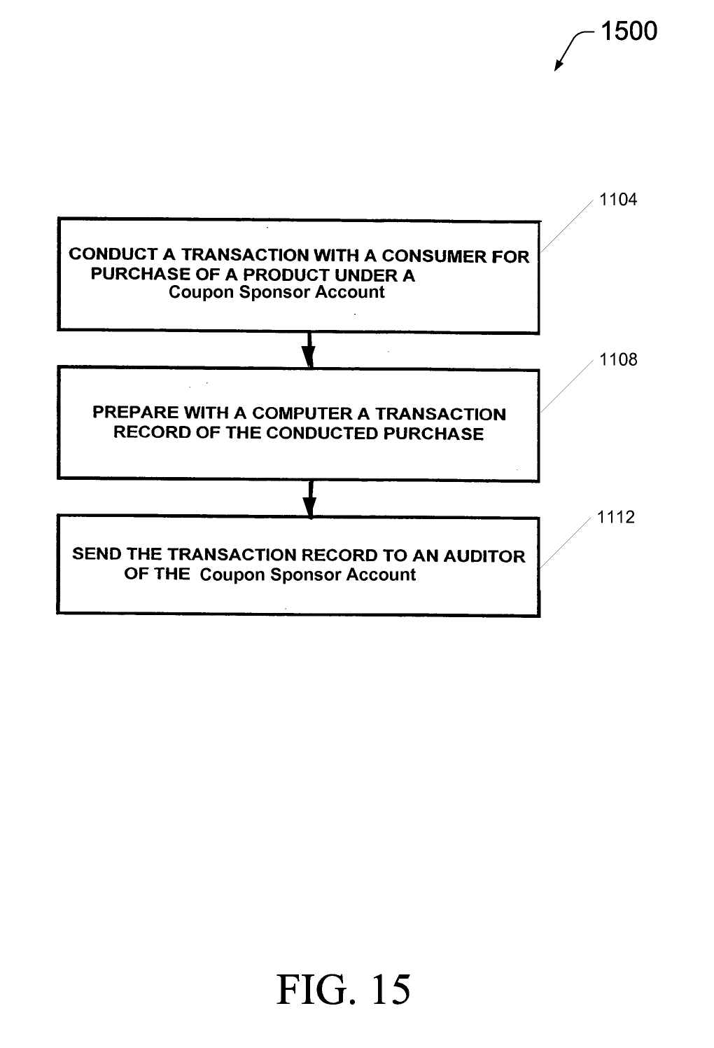

FIG. 15 illustrates a flow chart demonstrating a method 1500 of implementing the compliance procedure according to one embodiment of the invention. In method 1500, block 1104 illustrates that a transaction between a patient and a healthcare provider can be conducted for purchase of a flu vaccine upon a flu vaccine sponsor account. A computer transaction record of the conducted purchase can be prepared in block 1108. Then, the transaction record can be sent to an auditor of transactions conducted upon the flu vaccine sponsor account in block 1112.

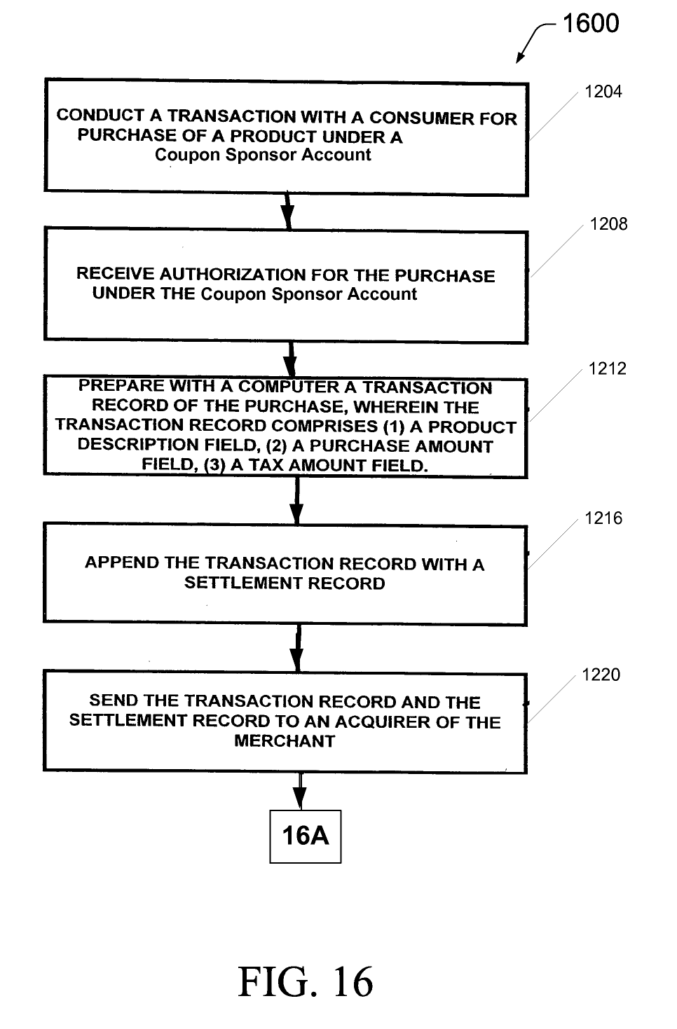

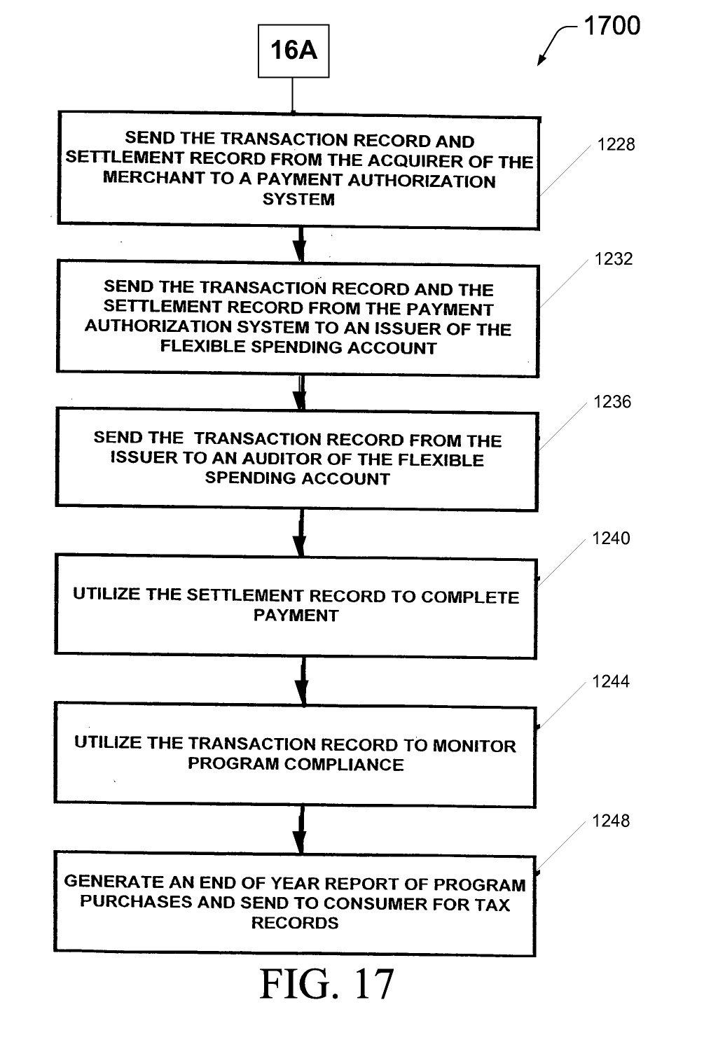

FIGS. 16-17 illustrate a flow chart which demonstrates a method shown by blocks 1204-1248 according to a more detailed implementation. In block 1204 seen at reference numeral 1600, a transaction with a patient is conducted by a healthcare service provider for administering a flu vaccine upon a flu vaccine sponsor account. An authorization request is submitted and authorization is received for the purchase on the flu vaccine sponsor account as shown in block 1208. A computer transaction record can then be prepared for the purchase. For example, one example of a transaction record would comprise a product description field, a purchase amount field, and a tax amount for the purchase amount as shown in block 1212. This can be seen in more detail in FIGS. 18A-18B.

FIG. 18A shows that a payment network settlement record can be appended with additional information about a flu vaccine sponsor account purchase, wherein that information is referred to as a transaction record. FIG. 18B illustrates a more detailed view of the transaction record shown in FIG. 18A. Namely, FIG. 18B shows that a product code field can be entered as part of the transaction record. In addition, the quantity of products can be included as an additional field. Also, an item descriptor providing additional information about the product can be included as a field. Also, a line item amount can be included to indicate the amount for the item. Similarly, a tax field can be included to indicate the tax for the item. Furthermore, the line item total for the product can be included as a field. Similarly, a product category field can be included. All of this information, or only part of it, can be utilized for the transaction record.

In block 1216 of FIG. 16 the transaction record is appended to the payment network settlement record as was noted in FIG. 18A. The transaction record and the settlement record can then be sent to an acquirer of the merchant as shown on block 1220 and forwarded to the payment authorization system as shown at reference box 16A leading to block 1228 of FIG. 17. Furthermore, the transaction record and settlement record can be forwarded by the payment network system to the issuer of the flu vaccine sponsor account as shown in block 1232. At this point, the transaction record can be sent to an auditor of the flu vaccine sponsor account as shown in block 1236. Alternatively, the issuer of the flu vaccine sponsor account may be configured to process the transaction record itself. Thus, for example, an issuer may determine whether a transaction record for a transaction conducted upon a flu vaccine sponsor account was properly considered a qualified transaction. If the issuer does not perform the compliance process, it may forward the transaction record to a third party processor or to the sponsor the flu vaccine program. Thus, for example, the third party processor may be tasked with the job of determining whether a transaction was properly qualified according to the guidelines of a flu vaccine sponsor account. Similarly, the sponsor may be configured to perform the compliance process itself. Block 1240 of FIG. 17 shows that the payment network settlement record is utilized to complete payment on the transaction as would normally be conducted by an issuer.

One of the benefits of the forwarding of the transaction information through a payment network settlement record to the issuer of a sponsor account or to the sponsor is that a statement can be compiled for forwarding to the patient, if desired, that indicates all the transactions that were made under the flu vaccine sponsor account. Additionally, transaction records forwarded by multiple healthcare service providers (e.g.; merchants) can be delivered to the issuer of a sponsor account or to the sponsor using the same format and delivery method. This can be of assistance to the patient (i.e., the consumer of healthcare services) for purposes of reporting on the consumer's taxes as shown in block 1248, if desired or permissible.

A benefit of one implementation is that these processes can serve as a standard that multiple retailers, issuers, processors and third party administrators can use. Thus, rather than requiring an individual or company to provide documentation regarding purchases made with flu vaccine sponsor account prepaid or entitlement cards, the authorization and settlement procedures can be used to supply the information expeditiously. Similarly, rather than requiring a retailer to provide to a third party administrator or its processor a list of items that were purchased with a flu vaccine sponsor account prepaid or entitlement card via a direct connection between the retailer (or retailer's agent) and the third party administrator—a system that involves substantial overhead in view of the fact that the retailer would have to configure a direct connection with each and every third party administrator—present implementations invention avoid such overhead and do not require retailers to support different database extract formats for different third party administrators and/or processors for third party administrators, nor do such implementations require the third party administrators and/or processors to support the receipt of different formats, media, and communications methods for different retailers.

A benefit of one implementation can allow the real-time automatic substantiation (i.e.; auto-substantiation) of qualified amounts for payment card expenditures from flu vaccine sponsor accounts, thereby reducing the costs associated with flu vaccine sponsor accounts and the related substantiation requirements.

Implementations disclosed above involve a flu vaccine sponsor account prepaid or entitlement card for use by a patient to purchase a flu vaccine from a healthcare service provider, where the purchase is made upon a sponsor account issued to a flu vaccine sponsor by an issuer. It is also contemplated, however, that the above disclosed implementation can also be applied, in concept and functionality, to a governmental healthcare service card for use by a patient to purchase a healthcare-related good or service from a healthcare service provider, where the purchase is made upon an account issued by an issuer to a government entity who is financially responsible for the provision of healthcare services to the patient. By way of example relevant to the USA., and not by way of limitation, such a government healthcare service card can be a Medicare and/or Medicaid card. As referred to herein, Medicare and Medicaid are administered by governmental entities to provide health insurance coverage to people who meet special criteria. In some cases, a transaction is conducted between a healthcare service provider and a patient upon an account issued to a governmental entity who is a single-payer for the healthcare services provided by patients covered for healthcare services under the governmental entity. For instance, Medicare operates as a single-payer health care system.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps, each being performed by hardware executing software, wherein the steps include:
receiving, at an address of an issuer of a healthcare service sponsor account from an address of a transaction handler, a payment network authorization request message originating from an address of a healthcare provider, wherein:
the payment network authorization request message includes:
a healthcare service sponsor account identifier for the healthcare service sponsor account issued by the issuer to a sponsor who is financially responsible for reimbursing the healthcare provider for a cost of providing a healthcare service to a patient;
an identifier for the healthcare service;
an amount for the cost of providing the healthcare service to the patient; and
an identifier, corresponding to the healthcare service sponsor account, that is globally unique for a single purpose card redeemable by a bearer thereof for the redemption of the cost of providing the healthcare service;
and
the payment network authorization request message does not include information that identifies for the patient;
validating use of the healthcare service sponsor account for payment of the cost of providing the healthcare service to the patient;
sending, from the address of the issuer of the healthcare service sponsor account, for delivery to the address of the healthcare provider through the transaction handler, in response to said payment network authorization request message, an authorization approval message;
deactivating for future use the identifier, corresponding to the healthcare service sponsor account, that is globally unique for the single purpose card; and
when the healthcare service sponsor account has insufficient funds to reimburse the healthcare provider for the qualified amount of the total purchase amount, sending a request for the insufficient funds for delivery to an address of the sponsor.

2. A method as defined in claim 1, wherein the single purpose card is selected from the group consisting of:
an entitlement card corresponding to a payment for the healthcare service after redemption of the entitlement card by a bearer thereof, wherein the redemption is at a pre-negotiated price for the healthcare service that is pre-negotiated prior to delivery of the healthcare service to the patient; and
a prepaid card corresponding to a payment for the healthcare service after redemption of the prepaid card by a bearer thereof, wherein the redemption is from prepaid funds on deposit in the healthcare service sponsor account.

3. A method as defined in claim 1, wherein:
the amount included in the payment network authorization request message comprises:
a total purchase amount; and
a qualified amount of the total purchase amount;
and
the validating uses the healthcare service sponsor account identifier for payment of the qualified amount of the total purchase amount for the healthcare service.

4. The method as defined in claim 1, wherein the healthcare service is an administration of a controlled substance for which the patient does not have a prescription that is a biological preparation administered for improving an immunity of the patient to a particular disease.

5. The method as defined in claim 1, wherein the identifier for the healthcare service is selected from the group consisting of:
a Stock Keeping Unit (SKU);
a Universal Product Code (UPC);
a trademark;
a commodity type and a trade name of a provider of the commodity type;
an ingredient of the commodity type and the trade name of the provider of the commodity type; and
a combination of the foregoing.

6. A non-transient computer readable medium comprising instructions which, when executed by a computer, the computer performs the method of claim 1.

7. A method comprising a plurality of steps each being performed by hardware executing software, wherein the steps include:
reading from information encoded in a portable consumer payment device:
a healthcare service to be administered by a healthcare provider to a patient;
a controlled substance for which the patient does not have a prescription; and
a healthcare service sponsor account identifier for a healthcare service sponsor account issued to a sponsor who is financially responsible for reimbursing the unidentified healthcare provider for the cost of providing the healthcare service to the patient by payment from the healthcare service sponsor account for an administration of the controlled substance by the healthcare provider to the patient;
for a match of a healthcare service inventory code corresponding to the healthcare service and a match of the healthcare service inventory code to a qualified healthcare service category under said healthcare service sponsor account, forming a transmission containing a payment network authorization request message requesting use of said healthcare service sponsor account for a payment transaction request for the healthcare service, wherein:
said payment network authorization request message includes:
a total purchase amount for the matching said obtained healthcare service inventory code; and
a qualified amount of the total purchase amount eligible for use of said healthcare service sponsor account for the payment transaction request for the healthcare service;
and
said payment network authorization request message does not include information that identifies the patient;
sending the payment network authorization request message from an address of the healthcare provider for delivery to an address of an issuer of the healthcare service sponsor account; and
receiving at the address of the healthcare provider, in response to said payment network authorization request message, an authorization approval message originating from the address of the issuer of the healthcare service sponsor account.

8. A method as defined in claim 7, wherein the portable consumer payment device is selected from the group consisting of:
a single purpose entitlement card corresponding to a payment for the healthcare service after redemption of the entitlement card by a bearer thereof, wherein the redemption is at a pre-negotiated price for the healthcare service that is pre-negotiated prior to delivery of the healthcare service to the patient; and
a single purpose prepaid card corresponding to a payment for the healthcare service after redemption of the prepaid card by a bearer thereof, wherein the redemption is from prepaid funds on deposit in the healthcare service sponsor account.

9. A method as defined in claim 7, wherein the steps further comprise deactivating for future use an identifier that is:
globally unique for the portable consumer payment device; and
encoded in the information in the portable consumer payment device.

10. The method as defined in claim 7, wherein the controlled substance is a biological preparation administered for improving an immunity of the patient to a particular disease.

11. A non-transient computer readable medium comprising instructions which, when executed by a computer, the computer performs the method of claim 7.

12. A method of authorizing a payment transaction request through a payment network for a healthcare service to be administered by a healthcare provider to a patient, wherein the payment transaction is conducted upon a healthcare service sponsor account, said method comprising a plurality of steps each being performed by hardware executing software, wherein the steps include:
obtaining a healthcare service sponsor account identifier for the healthcare service sponsor account, wherein:
the healthcare service sponsor account identifier is encoded in a portable consumer payment device;
the portable consumer payment device contains encoded information that identifies the healthcare service that is to be administered to a patient;
the healthcare service includes:
a controlled substance for which the patient does not have a prescription; and
an administration of the controlled substance by the healthcare provider to the patient;
the healthcare service sponsor account is issued to a sponsor who is financially responsible for reimbursing the healthcare provider for the cost of providing the healthcare service to the patient;
determining that the obtained healthcare service sponsor account identifier is valid by matching said healthcare service sponsor account identifier against a stored set of healthcare service sponsor account identifiers;
for the matching said healthcare service sponsor account identifier:
obtaining a healthcare service inventory code corresponding to the healthcare service; and
determining:
that the obtained healthcare service inventory code matches a qualified healthcare service category under said healthcare service sponsor account;
a total purchase amount for the matching said obtained healthcare service inventory code; and
a qualified amount of the total purchase amount eligible for use of said healthcare service sponsor account;
and
for the matching said obtained healthcare service inventory code, forming a transmission containing a payment network authorization request message requesting use of said healthcare service sponsor account for payment for the healthcare service, wherein:
said payment network authorization request message includes:
the total purchase amount for the matching said obtained healthcare service inventory code; and
the qualified amount of the total purchase amount eligible for use of said healthcare service sponsor account for the payment transaction request for the healthcare service;
and
said payment network authorization request message does not includes an identification of the patient;
sending said payment network authorization request message from an address of the healthcare provider for delivery, through an acquirer for the healthcare provider and through a transaction handler, to an address of an issuer of the healthcare service sponsor account who issued to the healthcare service sponsor account to the sponsor;
receiving at the address of the healthcare provider, in response to said payment network authorization request message, an authorization approval message originating from the address of the issuer.

13. The method as defined in claim 12, wherein the steps further comprise:
preparing a transaction record of said payment transaction; and
sending said transaction record to an address of an auditor of said healthcare service sponsor account.

14. The method as defined in claim 12, wherein the portable consumer payment device is selected from the group consisting of:
a single purpose entitlement card corresponding to a payment for the healthcare service after redemption of the entitlement card by a bearer thereof, wherein the redemption is at a pre-negotiated price for the healthcare service that is pre-negotiated prior to delivery of the healthcare service to the patient; and
a single purpose prepaid card corresponding to a payment for the healthcare service after redemption of the prepaid card by a bearer thereof, wherein the redemption is from prepaid funds on deposit in the healthcare service sponsor account.

15. A method as defined in claim 12, wherein the steps further comprise deactivating for future use an identifier that is:
globally unique for the portable consumer payment device; and
encoded in the information in the portable consumer payment device.

16. The method as defined in claim 12, wherein the controlled substance is a biological preparation administered for improving an immunity of the patient to a particular disease.

17. The method as defined in claim 12, wherein:
the healthcare service sponsor account identifier for the healthcare service sponsor account is obtained at an electronic point of service terminal (POS);
the determining that the obtained healthcare service sponsor account identifier is valid is performed using the POS; and
the POS is used to:
obtain the healthcare service inventory code corresponding to the healthcare service; and
determine:
that the obtained healthcare service inventory code matches a qualified healthcare service category under said healthcare service sponsor account;
the total purchase amount for the matching said obtained healthcare service inventory code; and
the qualified amount of the total purchase amount eligible for use of said healthcare service sponsor account for the payment transaction request for the healthcare service.

18. The method as defined in claim 12, wherein the portable consumer payment device includes information that identifies the patient.

19. The method as defined in claim 12, wherein the steps further comprise, after the receiving of the authorization approval message, deactivating the portable consumer payment device for future use of other said patients to receive the administration of the healthcare service.

20. The method as defined in claim 19, wherein:
the portable consumer payment device includes information encoding a plurality of identifiers each corresponding to one said healthcare service; and
the deactivating further comprises deactivating the corresponding said identifier of the corresponding said healthcare service that was administered to the patient for future use by other said patients.

21. A non-transient computer readable medium comprising instructions which, when executed by a computer, the computer performs the method of claim 12.
